(19) United States
(12) Patent Application Publication
(10) Pub. No.: US 2025/0151045 A1
(43) Pub. Date: May 8, 2025

(54) SCHEDULING REQUESTS FOR SPATIAL MULTIPLEXING

(71) Applicant: QUALCOMM Incorporated, San Diego, CA (US)

(72) Inventors: Stelios STEFANATOS, San Diego, CA (US); Kapil GULATI, Belle Mead, NJ (US); Junyi LI, Greentown, PA (US); Preeti KUMARI, San Diego, CA (US)

(21) Appl. No.: 18/838,742

(22) PCT Filed: Mar. 17, 2023
(86) PCT No.: PCT/US2023/015463

§ 371 Date: Aug. 15, 2024

(30) Foreign Application Priority Data
Apr. 15, 2022 (GR) 20220100328

(51) Int. Cl. H04W 72/044; H04L 5/00; H04W 72/12

(52) U.S. Cl. CPC H04W 72/046; H04L 5/0091; H04W 72/12

(57) ABSTRACT

Methods, systems, and devices for wireless communications are described. A user equipment (UE) may transmit an uplink message (e.g., a scheduling request) indicating one or more beam directions (e.g., one beam direction, a set of beam directions, a sequence of beam directions), one or more beamwidths (e.g., for the one or more indicated beam directions), an angular area of interest for radar sensing, or a combination thereof. The network entity may then provide, to the UE, a grant of resources for performing the radar sensing on specific radar sensing transmit beams (e.g., that will not interfere with other radar sensing by other UEs, uplink communications form other UEs, sidelink communications by other UEs, etc.). The UE may indicate the directions of the beams with reference to a global coordinate system. The network may configure the UE with lookup tables (LUTs) defining relationships between indices, beam directions and/or beamwidths.

### CROSS REFERENCE

The present Application is a 371 national stage filing of International PCT Application No. PCT/US2023/015463 by STEFANATOS et al., entitled “SCHEDULING REQUESTS FOR SPATIAL MULTIPLEXING,” filed Mar. 17, 2023; and claims priority to Greece patent application Ser. No. 20/220,100328 by STEFANATOS et al., entitled “SCHEDULING REQUESTS FOR SPATIAL MULTIPLEXING,” filed Apr. 15, 2022, each of which is assigned to the assignee hereof, and each of which is expressly incorporated by reference herein.

### FIELD OF TECHNOLOGY

The following relates to wireless communications, including scheduling requests for spatial multiplexing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support scheduling requests for spatial multiplexing. In some examples, a user equipment (UE) may transmit an uplink message (e.g., a scheduling request) indicating one or more beam directions (e.g., one beam direction, a set of beam directions, a sequence of beam directions), one or more beamwidths (e.g., for the one or more indicated beam directions), an angular area of interest for radar sensing, or a combination thereof. The network entity may provide to the UE a grant of resources for performing the radar sensing on specific radar sensing transmit beams (e.g., that will not interfere with other radar sensing by other UEs, uplink communications form other UEs, sidelink communications by other UEs, etc.).

A method for wireless communications at a user equipment (UE) is described. The method may include transmitting a scheduling request including one or more of: an indication of a set of one or more radar sensing transmit beams, an indication of one or more beamwidth values for respective ones of the one or more radar sensing transmit beams, or an angular area of interest for radar sensing, receiving a control message indicating a grant of resources on a physical shared channel based on transmitting the scheduling request, and transmitting one or more radar signals according to the grant of resources on the physical shared channel.

An apparatus for wireless communications at a UE is described. The apparatus may include a processor, memory coupled with the processor, and instructions stored in the memory. The instructions may be executable by the processor to cause the apparatus to transmit a scheduling request including one or more of: an indication of a set of one or more radar sensing transmit beams, an indication of one or more beamwidth values for respective ones of the one or more radar sensing transmit beams, or an angular area of interest for radar sensing, receive a control message indicating a grant of resources on a physical shared channel based on transmitting the scheduling request, and transmit one or more radar signals according to the grant of resources on the physical shared channel.

Another apparatus for wireless communications at a UE is described. The apparatus may include means for transmitting a scheduling request including one or more of: an indication of a set of one or more radar sensing transmit beams, an indication of one or more beamwidth values for respective ones of the one or more radar sensing transmit beams, or an angular area of interest for radar sensing, means for receiving a control message indicating a grant of resources on a physical shared channel based on transmitting the scheduling request, and means for transmitting one or more radar signals according to the grant of resources on the physical shared channel.

A non-transitory computer-readable medium storing code for wireless communications at a UE is described. The code may include instructions executable by a processor to transmit a scheduling request including one or more of: an indication of a set of one or more radar sensing transmit beams, an indication of one or more beamwidth values for respective ones of the one or more radar sensing transmit beams, or an angular area of interest for radar sensing, receive a control message indicating a grant of resources on a physical shared channel based on transmitting the scheduling request, and transmit one or more radar signals according to the grant of resources on the physical shared channel.

Some examples of the method, apparatuses, and non-transitory computer-readable medium described herein may further include operations, features, means, or instructions for receiving control signaling including an indication of a relationship between a set of indices, respective radar sensing transmit beams of a set of multiple radar sensing transmit beams including the set of one or more radar sensing transmit beams, and respective beamwidth values of a set of multiple beamwidth values including the one or more beamwidth values.

Some examples of the method, apparatuses, and non-transitory computer-readable medium described herein may further include operations, features, means, or instructions for transmitting, in the scheduling request, one or more indices of the set of indices associated with the set of one or more radar sensing transmit beams and the one or more beamwidth values.

Some examples of the method, apparatuses, and non-transitory computer-readable medium described herein may further include operations, features, means, or instructions for transmitting a capability message including an indication that the UE may be capable of supporting radar sensing and uplink signaling, where receiving the control signaling may be based on transmitting the capability message.

Some examples of the method, apparatuses, and non-transitory computer-readable medium described herein may further include operations, features, means, or instructions for receiving control signaling including an indication of a first relationship between a first set of indices and respective radar sensing transmit beams of a set of multiple radar sensing transmit beams including the set of one or more radar sensing transmit beams and an indication of a second relationship between a second set of indices and respective beamwidth values of a set of multiple beamwidth values including the one or more beamwidth values.

Some examples of the method, apparatuses, and non-transitory computer-readable medium described herein may further include operations, features, means, or instructions for transmitting, in the scheduling request, one or more indices of the first set of indices associated with the set of one or more radar sensing transmit beams, and one or more indices of the second set of indices associated with the one or more beamwidth values.

Some examples of the method, apparatuses, and non-transitory computer-readable medium described herein may further include operations, features, means, or instructions for transmitting a capability message including an indication that the UE may be capable of supporting simultaneous radar sensing and uplink signaling, where receiving the control signaling may be based on transmitting the capability message.

In some examples of the method, apparatuses, and non-transitory computer-readable medium described herein, the indication of the set of one or more radar sensing transmit beams may include operations, features, means, or instructions for an indication of a direction of each of the one or more radar sensing transmit beams with reference to a coordinate system.

In some examples of the method, apparatuses, and non-transitory computer-readable medium described herein, the direction of each of the set of one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

Some examples of the method, apparatuses, and non-transitory computer-readable medium described herein may further include operations, features, means, or instructions for transmitting, in the scheduling request, an indication of one or more radar sensing receive beams, an indication of a position of a receiver for cooperative radar sensing, or both.

Some examples of the method, apparatuses, and non-transitory computer-readable medium described herein may further include operations, features, means, or instructions for transmitting, in the scheduling request, an indication of a sequence of the one or more radar sensing transmit beams, a time period associated with radar sensing on each radar sensing transmit beam of the one or more radar sensing transmit beams, or both.

Some examples of the method, apparatuses, and non-transitory computer-readable medium described herein may further include operations, features, means, or instructions for receiving, in the grant of resources based on transmitting the scheduling request including the angular area of interest for radar sensing, an indication of a sequence of the set of one or more radar sensing transmit beams associated with the angular area of interest for radar sensing, where transmitting the one or more radar signals according to the grant of resources on the physical shared channel includes transmitting the one or more radar signals according to the sequence of the set of one or more radar sensing transmit beams.

Some examples of the method, apparatuses, and non-transitory computer-readable medium described herein may further include operations, features, means, or instructions for receiving, in the grant of resources based on transmitting the scheduling request including the indication of the set of one or more radar sensing transmit beams, an indication of a second set of one or more radar sensing transmit beams associated with the angular area of interest for radar sensing, where transmitting the one or more radar signals according to the grant of resources on the physical shared channel includes transmitting the one or more radar signals using the second set of one or more radar sensing transmit beams.

In some examples of the method, apparatuses, and non-transitory computer-readable medium described herein, the set of one or more radar sensing transmit beams may be different from the second set of one or more radar sensing transmit beams.

Some examples of the method, apparatuses, and non-transitory computer-readable medium described herein may further include operations, features, means, or instructions for transmitting, in the scheduling request, a threshold bandwidth for transmitting the one or more radar signals, a threshold time duration for transmitting the one or more radar signals, a threshold transmit power for transmitting the one or more radar signals, an indication of a position of the UE, or any combination thereof.

A method for wireless communications at a network entity is described. The method may include transmitting control signaling including an indication of a set of multiple radar sensing transmit beams and a set of multiple beamwidth values associated with the set of multiple radar sensing transmit beams, receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE, and transmitting, based on receiving the scheduling request, a control message indicating a grant of resources for performing radar sensing on a physical shared channel.

An apparatus for wireless communications at a network entity is described. The apparatus may include a processor, memory coupled with the processor, and instructions stored in the memory. The instructions may be executable by the processor to cause the apparatus to transmit control signaling including an indication of a set of multiple radar sensing transmit beams and a set of multiple beamwidth values associated with the set of multiple radar sensing transmit beams, receive, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE, and transmit, based on receiving the scheduling request, a control message indicating a grant of resources for performing radar sensing on a physical shared channel.

Another apparatus for wireless communications at a network entity is described. The apparatus may include means for transmitting control signaling including an indication of a set of multiple radar sensing transmit beams and a set of multiple beamwidth values associated with the set of multiple radar sensing transmit beams, means for receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE, and means for transmitting, based on receiving the scheduling request, a control message indicating a grant of resources for performing radar sensing on a physical shared channel.

A non-transitory computer-readable medium storing code for wireless communications at a network entity is described. The code may include instructions executable by a processor to transmit control signaling including an indication of a set of multiple radar sensing transmit beams and a set of multiple beamwidth values associated with the set of multiple radar sensing transmit beams, receive, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE, and transmit, based on receiving the scheduling request, a control message indicating a grant of resources for performing radar sensing on a physical shared channel.

Some examples of the method, apparatuses, and non-transitory computer-readable medium described herein may further include operations, features, means, or instructions for receiving a capability message including an indication that the UE may be capable of supporting simultaneous radar sensing and uplink signaling, where transmitting the control signaling may be based on receiving the capability message.

In some examples of the method, apparatuses, and non-transitory computer-readable medium described herein, transmitting the control signaling may include operations, features, means, or instructions for transmitting an indication of a relationship between a set of indices, respective radar sensing transmit beams of the set of multiple radar sensing transmit beams, and respective beamwidth values of the set of multiple beamwidth values.

Some examples of the method, apparatuses, and non-transitory computer-readable medium described herein may further include operations, features, means, or instructions for receiving, in the scheduling request, one or more indices of the set of indices associated with the set of one or more radar sensing transmit beams and the one or more beamwidth values.

In some examples of the method, apparatuses, and non-transitory computer-readable medium described herein, transmitting the control signaling may include operations, features, means, or instructions for transmitting an indication of a first relationship between a first set of indices and respective radar sensing transmit beams of the set of multiple radar sensing transmit beams and an indication of a second relationship between a second set of indices and respective beamwidth values of the set of multiple beamwidth values.

Some examples of the method, apparatuses, and non-transitory computer-readable medium described herein may further include operations, features, means, or instructions for receiving, in the scheduling request, one or more indices of the first set of indices associated with the set of one or more radar sensing transmit beams, and one or more indices of the second set of indices associated with the one or more beamwidth values.

In some examples of the method, apparatuses, and non-transitory computer-readable medium described herein, the indication of the set of one or more radar sensing transmit beams may include operations, features, means, or instructions for an indication of a direction of each of the one or more radar sensing transmit beams with reference to a coordinate system.

In some examples of the method, apparatuses, and non-transitory computer-readable medium described herein, the direction of each of the one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

Some examples of the method, apparatuses, and non-transitory computer-readable medium described herein may further include operations, features, means, or instructions for receiving, in the scheduling request, an indication of one or more radar sensing receive beams, an indication of a position of a receiver for cooperative radar sensing, or both.

Some examples of the method, apparatuses, and non-transitory computer-readable medium described herein may further include operations, features, means, or instructions for receiving, in the scheduling request, an indication of a sequence of the one or more radar sensing transmit beams, a time period associated with radar sensing on each radar sensing transmit beam of the one or more radar sensing transmit beams, or both.

Some examples of the method, apparatuses, and non-transitory computer-readable medium described herein may further include operations, features, means, or instructions for identifying, based on receiving the scheduling request including the indication of the angular area of interest for radar sensing, a sequence of the set of one or more radar sensing transmit beams that satisfies an interference threshold associated with uplink signaling, radar sensing, or both, within the angular area of interest and transmitting, in the grant of resources, an indication of the sequence of the set of one or more radar sensing transmit beams.

Some examples of the method, apparatuses, and non-transitory computer-readable medium described herein may further include operations, features, means, or instructions for identifying, based on receiving the scheduling request including the indication of the set of one or more radar sensing transmit beams, a second set of one or more radar sensing transmit beams that may be available for radar sensing by the UE and transmitting, in the grant of resource, an indication of the second set of one or more radar sensing transmit beams.

Some examples of the method, apparatuses, and non-transitory computer-readable medium described herein may further include operations, features, means, or instructions for receiving, in the scheduling request, a threshold bandwidth for transmitting one or more radar signals, a threshold time duration for transmitting each of the one or more radar signals, a threshold transmit power for transmitting the one or more radar signals, or any combination thereof.

### BRIEF DESCRIPTION OF THE DRAWINGS

FIG. 1 illustrates an example of a wireless communications system that supports scheduling requests for spatial multiplexing in accordance with one or more aspects of the present disclosure.

FIG. 2 illustrates an example of a wireless communications system that supports scheduling requests for spatial multiplexing in accordance with one or more aspects of the present disclosure.

FIG. 3 illustrates an example of a beam information scheme that supports scheduling requests for spatial multiplexing in accordance with one or more aspects of the present disclosure.

FIG. 4 illustrates an example of a process flow that supports scheduling requests for spatial multiplexing in accordance with one or more aspects of the present disclosure.

FIGS. 5 and 6 show block diagrams of devices that support scheduling requests for spatial multiplexing in accordance with one or more aspects of the present disclosure.

FIG. 7 shows a block diagram of a communications manager that supports scheduling requests for spatial multiplexing in accordance with one or more aspects of the present disclosure.

FIG. 8 shows a diagram of a system including a device that supports scheduling requests for spatial multiplexing in accordance with one or more aspects of the present disclosure.

FIGS. 9 and 10 show block diagrams of devices that support scheduling requests for spatial multiplexing in accordance with one or more aspects of the present disclosure.

FIG. 11 shows a block diagram of a communications manager that supports scheduling requests for spatial multiplexing in accordance with one or more aspects of the present disclosure.

FIG. 12 shows a diagram of a system including a device that supports scheduling requests for spatial multiplexing in accordance with one or more aspects of the present disclosure.

FIGS. 13 through 16 show flowcharts illustrating methods that support scheduling requests for spatial multiplexing in accordance with one or more aspects of the present disclosure.

### DETAILED DESCRIPTION

Some wireless communications systems may support radar sensing (e.g., transmitting directional radar sensing signals in any direction for target detection or target tracking). A wireless node (e.g., a user equipment (UE)) may support uplink communications and radar sensing using communication resources (e.g., on a physical uplink shared channel (PUSCH)). The transmission of directional radar sensing signals may result in interference with radar signaling or uplink signaling, or both. To mitigate such interference, a wireless network could support allocation of specific time and frequency resources (e.g., time division multiplexing (TDM) or frequency division multiplexing (FDM) schemes) for radar sensing. However, such multiplexing schemes may result in problems such as excessive delays, a lack of available resources, system resource congestion, increased system latency, or failed radar sensing procedures. In some examples, a wireless communication system may also support spatial multiplexing for radar sensing to avoid radar-to-radar interference, or radar-to-uplink interference. Thus, a wireless communications system may support joint use of shared resources (e.g., on a PUSCH) for radar sensing and uplink signaling, and network entities may configure UEs with spatial resources to avoid collisions and interference. However, the network may not be able to successfully configure spatial resources for radar sensing at the UE (e.g., to avoid interference) without access to information regarding beam directions of various UEs or areas of interest for radar sensing (e.g., to avoid radar-to-radar interference or radar-to-uplink interference).

A UE may support beam management techniques for bidirectional communications (e.g., uplink signaling). Such beam management techniques may support identification and selection of specific beam pairs (e.g., transmit beams and receive beams) for communications between a transmitting wireless node and a receiving wireless node. However, such techniques may result in unnecessary signaling overhead for, or may be irrelevant to, beam management for radar sensing techniques. That is, determining a transmit beam for radar sensing may be different than determining a beam pair for bidirectional communications (e.g., may not rely on the same nuances, may be feasible with less signaling, among other examples). Therefore, scheduling requests and beam management techniques supported for uplink signaling may not be sufficient or efficient for radar sensing beam management.

In some examples, as described herein, a UE may transmit an uplink message (e.g., a scheduling request) indicating one or more beam directions (e.g., one beam direction, a set of beam directions, a sequence of beam directions), one or more beamwidths (e.g., for the one or more indicated beam directions), an angular area of interest for radar sensing, or a combination thereof. The network entity may then provide, to the UE, a grant of time-frequency resources (e.g., on a PUSCH) for performing the radar sensing (e.g., over the same time-frequency resources) on specific radar sensing transmit beams (e.g., that will not interfere with other radar sensing by other UEs, uplink communications from other UEs, sidelink communications by other UEs, etc.).

The UE may indicate the directions of the beams with reference to a global coordinate system. The UE may indicate the beam directions and/or beamwidths using real numbers (e.g., depending on an available resolution allowed by a number of supported bits in the radar sensing scheduling request). In some examples, the network may configure the UE with one or more lookup tables (LUTs) defining relationships between indices and beam directions and/or beamwidths. In some cases, the network may configure the UE with such LUTs in response to receiving capability information from the UE. The UE may indicate beam directions or beamwidths using indices associated with the LUTs. In some examples, the UE may indicate multiple beam directions (e.g., and beamwidths) for a beam sweep or sequence of beams, or may indicate multiple beam directions for a broad or coarse beam covering a same area as multiple narrow beams. A UE may support bistatic (e.g., cooperative) radar sensing procedures (e.g., where a first network node transmits a radar signal and another network node receives and measures the radar signal). In such examples, the UE may transmit (e.g., in the scheduling request) an indication of a receive beam, a location of a radar sensing receiver, a location of the sensing transmitter (e.g., supporting monostatic or bistatic sensing procedures) or a combination thereof.

In some examples, the UE may indicate (e.g., in the scheduling request) an angular region of interest (e.g., the sweeping sequence of the beams required to cover the region of interest may have no impact on the success of the radar sensing), a transmission duration for each radar sensing transmit beam, beamwidths of radar sensing transmit beams, or a combination thereof. In such examples, the network entity may determine a beam sweeping sequence for the radar sensing to decrease or avoid interference with other ongoing transmissions. The network entity may then transmit, in the uplink grant, an indication of a sequence of transmit beams the UE is to use for radar sensing. In some examples, the UE may indicate a set of preferred radar sensing transmit beams, and the network entity may indicate that the UE is to use those radar sensing transmit beams (e.g., if available without causing interference or experiencing interference from uplink signaling or other radar signaling), or a set of best available radar sensing transmit beams (e.g., available radar sensing transmit beams that are close to or similar to the requested radar sensing transmit beams, if the requested radar sensing transmit beams are unavailable due to interference). In some examples, the scheduling request may include one or more additional parameters, such as a threshold bandwidth for sensing transmission, a preferable threshold duration for transmission (e.g., a number of OFDM symbols, a number of slots or mini-slots, an absolute time period, among other examples), or a threshold transmit power (e.g., an absolute number in Watts, an index to a pre-configured LUT, a power headroom report (PHR), among other examples).

Aspects of the disclosure are initially described in the context of wireless communications systems. Aspects of the disclosure are further illustrated by and described with reference to wireless communications systems, beam information schemes, and process flows. Aspects of the disclosure are further illustrated by and described with reference to apparatus diagrams, system diagrams, and flowcharts that relate to scheduling requests for spatial multiplexing.

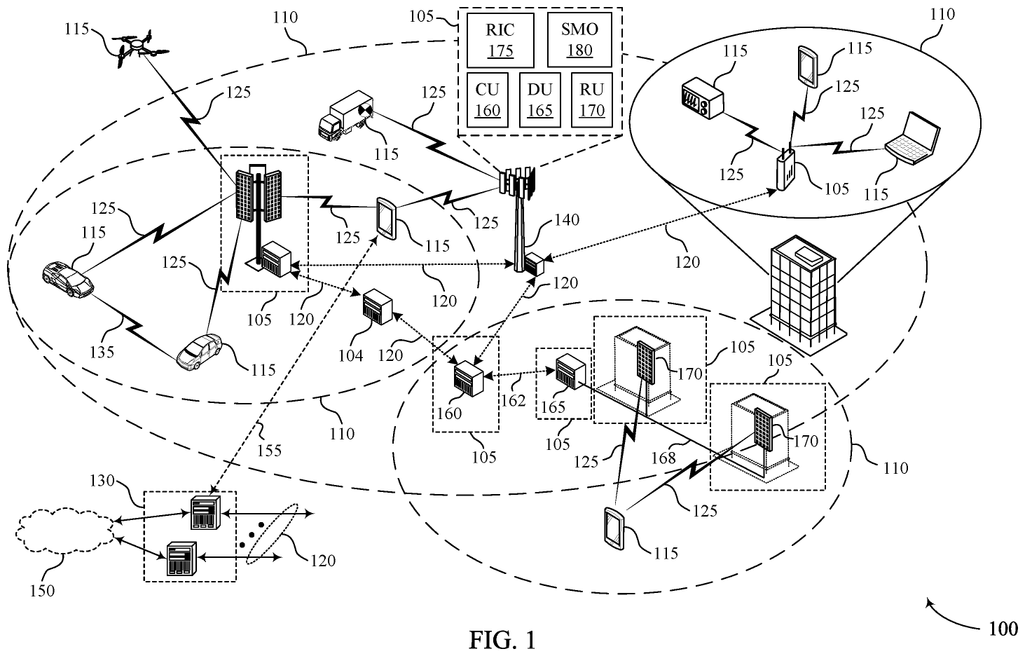

FIG. 1 illustrates an example of a wireless communications system 100 that supports scheduling requests for spatial multiplexing in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scheduling requests for spatial multiplexing as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, as described herein, a UE 115 may transmit an uplink message (e.g., a scheduling request) indicating one or more beam directions (e.g., one beam direction, a set of beam directions, a sequence of beam directions), one or more beamwidths (e.g., for the one or more indicated beam directions), an angular area of interest for radar sensing, or a combination thereof. The network entity may then provide, to the UE 115, a grant of resources (e.g., on a PUSCH) for performing the radar sensing on specific radar sensing transmit beams (e.g., that will not interfere with other radar sensing by other UEs 115, uplink communications form other UEs 115, sidelink communications by other UEs 115, etc.).

The UE may indicate the directions of the beams with reference to a global coordinate system. The UE may indicate the beam directions and/or beamwidths using real numbers (e.g., depending on an available resolution allowed by a number of supported bits in the radar sensing scheduling request). In some examples, the network may configure the UE 115 with one or more lookup tables (LUTs) defining relationships between indices and beam directions and/or beamwidths. In some cases, the network may configure the UE 115 with such LUTs in response to receiving capability information from the UE 115. The UE 115 may indicate beam directions or beamwidths using indices associated with the LUTs. In some examples, the UE 115 may indicate multiple beam directions (e.g., and beamwidths) for a beam sweep or sequence of beams, or may indicate multiple areas for a broad or coarse beam covering a same area as multiple narrow beams. A UE 115 may support bistatic (e.g., cooperative) radar sensing procedures (e.g., where a first network node transmits a radar signal and another network node receives and measures the radar signal). In such examples, the UE 115 may transmit (e.g., in the scheduling request) an indication of a receive beam, a location of a radar sensing receiver, a location of a radar sensing transmitter, or a combination thereof.

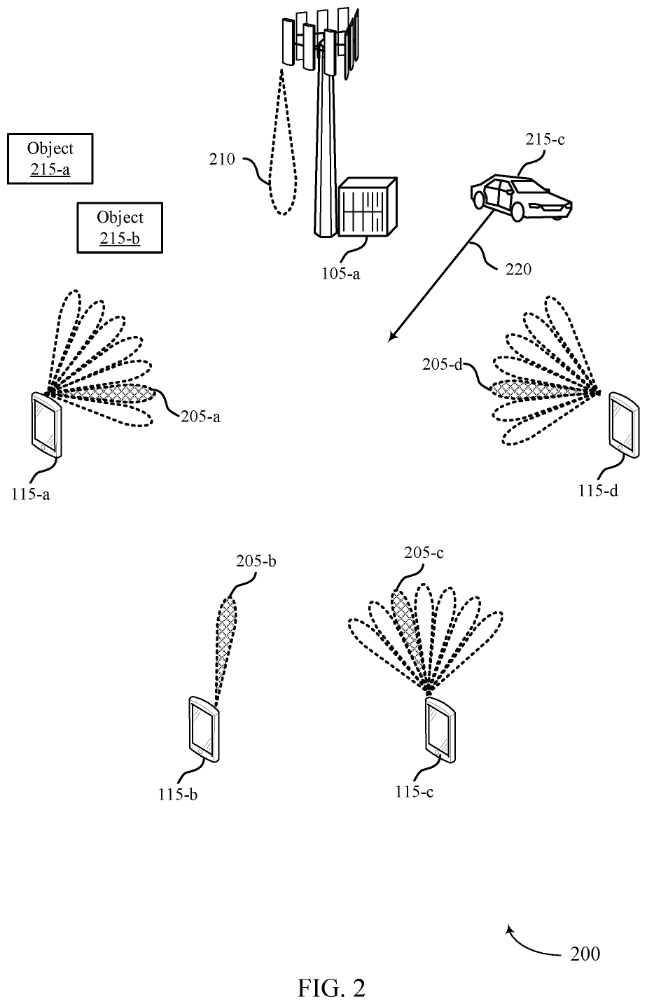

FIG. 2 illustrates an example of a wireless communications system 200 that supports scheduling requests for spatial multiplexing in accordance with one or more aspects of the present disclosure. Wireless communications system 200 may include one or more network entities 105 (e.g., the network entity 105-a), and one or more UEs 115 (e.g., the UE 115-a, the UE 115-b, the UE 115-c, and the UE 115-d), which may be examples of corresponding devices described with reference to FIG. 1. The wireless communications system 200 may also include one or more objects 215, which may be examples of structures, obstacles, surfaces, vehicles, people, pedestrians, or any other object. UEs 115 may support radar sensing, as well as other wireless communications (e.g., uplink wireless communications and downlink wireless communications). In some examples, techniques described herein (e.g., by the UEs 115) may be performed by any device equipped for or supporting radar sensing techniques.

Wireless communications system 200 may support radar sensing (e.g., which may be referred to as sensing as a service). In some examples (e.g., in a 5G system, a 6G system, among other examples), radar transmissions may be performed using same resources as other communication resources. For instance, the UEs 115 (e.g., or any other radar transmitters) may perform uplink communications or downlink communications with network entities 105, or sidelink communications with other UEs 115, using time frequency resources, and the same time frequency resources may be used (e.g., allocated by the network) for radar sensing. If the UEs 115 use uplink resources, for example, for radar sensing, the network may allocate the uplink resources (e.g., on a physical uplink shared channel (PUSCH)) for radar sensing. However, a large number of radar transmissions may occur within a relatively small period of time (e.g., 100 ms or less), and radar transmission may utilize a relatively large bandwidth (e.g., for achieving high range resolution of radar sensing). In such examples, scheduling radar transmissions over orthogonal time-frequency resources may result in a depletion of available communication resources (e.g., to accommodate all traffic including uplink and downlink traffic and radar traffic).

In some examples, as described herein, the network (e.g., via one or more network entity 105) may spatially multiplex radar transmission over the same time-frequency resources (e.g., leveraging the fact that radar transmission radiation typically focuses on a small angular direction of interest). However, a network entity 105 may not be able to efficiently allocate spatial resources (e.g., indicate radar sensing transmit beams) to one or more UEs 115 (e.g., or any radar transmitter) if the network entity 105 does not have access to information regarding transmit beam direction for various radar transmitters, beamwidths of radar transmissions, and other parameter values. For instance, various UEs 115 may perform radar transmissions that result in radar-to-radar interference, or radar-to-uplink interference. Techniques described herein provide for uplink signaling (e.g., a scheduling request) that provides the relevant information and parameters to the network, to facilitate spatial multiplexing of radar sensing.

Radar sensing may include using communication resources for radar sensing (e.g., sensing as a service). For example, a UE 115 may use radar sensing techniques (e.g., as described herein) for environment sensing, which may include examples such as object localization or tracking, or three dimensional map creation. Radar sensing may also include radar-assisted communications. For example, the wireless communications system 200 may support radar sensing information used for improving communication performance (e.g., a network entity 105-a and a UE 115 may identify current or future blockage conditions, and may proactively adjust beams 205 for wireless communications). In any such examples, angular position information may be important for most sensing applications (e.g., especially automotive sensing applications). In some examples, radar sensing may be performed using transmissions from a single node (e.g., no multi-TRP transmissions to enable triangulation), in which case multi-antenna transmissions and receptions may be used to extract angular information of sensed targets (e.g., objects 215).

In some examples, to support radar sensing, radar transmitters (e.g., such as the UEs 115) may rely on frequency or continuous changes of transmit beam direction. In some examples, a UE 115 may perform radar sensing over an angular region (e.g., a wide angular region). For instance, the UE 115-a may perform radar beam sweeping for angular scanning (e.g., over a wide angular range). The UE 115-a may sweep through a sweep of beams 205 (e.g., including transmit beam 205-a), and may transmit radar signals (e.g., and monitor for reflected radar signals) during the radar sensing procedure.

A time during which each beam 205 is active may be referred to as a coherent processing interval (CPI). The greater the CPI duration, the greater the detected range of objects 215 (e.g., processing gain) may be, and the greater a resolution of a target velocity estimate. For instance, the UE 115-a may sweep through a set of beams 205 to detect one or more objects 215 (e.g., the object 215-a and the object 215-b, which may be pedestrians, vehicles, blockages, objects, obstructions, or structures, among other examples). Each beam 205 of the set of transmit beams 205 may be active during a respective CPI. If all of the CPIs are the same, then each direction (e.g., associated with each beam 205 of the set of beams 205) may be treated equivalently. In some examples, different directions (e.g., associated with different beams 205) may have different CPIs. In some examples, the UE 115-a may perform radar sensing in all directions, or in particular angular areas of interest, to determine whether an object 215 is present, or to determine a location, direction, or velocity, among other examples, of the object 215-a and the object 215-b.

In some examples, to support radar sensing, radar transmitters (e.g., such as the UEs 115) may perform tracking of targets of interest (e.g., objects 215) that are changing angular position due to mobility. For instance, an object 215-c (e.g., a vehicle) may be moving in direction 220. In such examples, the UE 115-d may perform radar sensing using a set of transmit beams 205 (e.g., including the transmit beam 205-d) to track one or more parameters, such as the direction 220, location, or velocity, of the object 215-c. The UE may perform the radar sensing by selecting specific beams 205 (e.g., sequentially, or out of order based on predicted location, velocity, etc.) and performing radar transmissions using the selected beams 205.

As described herein, the network (e.g., via one or more network entities 105) may allocate spatial resources over shared time-frequency resources to the UEs 115 to support radar sensing using shared resources (e.g., on a PUSCH), because allocating time-frequency resources specifically for radar sensing may result in depletion of resources. The network entity 105-a and the UEs 115 (e.g., the UE 115-b) may support mechanisms for uplink and downlink beam management. For instance, the network entity 105-a and the UE 115-b may perform beam management procedures (e.g., for a Uu link) to align the network entity 105-a and the UE 115-b (e.g., to identify a beam pair, such as beam 210 and beam 205-b, on which the network entity 105-a and the UE 115-b may successfully communicate). However, such procedures may not be relevant to radar sensing procedures, because radar sensing may not include a receiving node (e.g., a UE 115-a may transmit a radar signal and monitor for a reflection of the radar signal, without reference to any receiving node). Such procedures may use a relatively stationary beam 205, a relatively narrow beam 205, or both.

Additionally, or alternatively, a cooperative radar sensing procedure (e.g., with a transmitting radar device and a receiving radar device that may or may not be collocated) may also rely on signaling between two nodes, but aligning a beam pair between the network entity 105-a and a UE 115 may be irrelevant for radar sensing. Therefore, beam management procedures for uplink and downlink communication may be irrelevant for radar sensing, or may lead to excessive signaling overhead for identifying beam pairs when a UE 115 merely needs resources allocated for radar transmitting (e.g., with no receiving node).

The network may grant resources for radar sensing for a UE 115 to use on a beam 205 that will not interfere with other uplink signaling, downlink signaling, radar signaling, or a combination thereof. A UE 115 performing radar sensing may transmit radar signals over arbitrary beams 205 in uplink resources may potentially cause interference (e.g., to a receiver at the network entity 105-a) when the beam happens to point in the direction of the network entity 105-a. For example, if the UE 115-b is performing uplink transmissions using beam 205-b, and the UE 115-c performs radar sensing using the beam 205-c, then the network entity 105-a (e.g., using receive beam 210) may experience interference caused by the radar transmissions by the UE 115-c.

In some examples, uncontrolled directivity of radar transmissions may cause radar-to-radar interference, when the radar transmit beam 205 of one UE 115 points to the direction of another UE 115 that performs radar sensing over the same time-frequency resources. For instance, the UE 115-a may transmit radar signaling on the transmit beam 205-a, and the UE 115-d may transmit radar signaling on the transmit beam 205-d. Because the transmit beam 205-a is pointed in the direction of the UE 115-d, and the transmit beam 205-d is pointed in the direction of the UE 115-a, the UE 115-a may cause interference for radar sensing at the UE 115-d, and vice versa. Thus, to support shared use of time-frequency resources for uplink and downlink traffic, as well as radar traffic, the UEs 115 may provide information to the network, allowing the network to schedule resources and avoid or mitigate radar-to-radar interference, radar-to-uplink interference, or both.

As described herein, a network entity 105-a may assign or allocate the same time-frequency resources (e.g., or partially overlapping time-frequency resources) to more than one UE 115 that performs uplink transmissions over beam directions that do not interfere with any communication link receiver (e.g., at the network entity 105-a) or radar receiver (e.g., at one or more wireless nodes which may include UEs 115, network entities 105, or any other radar capable device). Because all uplink UEs 115 may transmit uplink signaling toward the network entity 105-a, one of the multiplexed UEs 115 may perform uplink transmissions (e.g., the UE 115-b via the transmit beam 205-b), while other UEs 115 may perform radar sensing (e.g., on the same resources that the UE 115-b is using for uplink signaling).

To support such sharing of time-frequency resources, the UEs 115 may provide, to the network entity 105-a, one or more parameters that the network entity 105-a may use to spatially multiplex uplink traffic, downlink traffic, sidelink traffic, radar sensing, or any combination thereof. For example, the network entity 105-a may determine a transmit beam direction and/or transmit beam beamwidth (e.g., for radar transmitters, as the network may already have access to information regarding uplink transmit beams based on beam management procedures), a radar receiver position, a radar transmitter position, a radar receiver beam direction and/or beamwidth (e.g., for a radar receiver for radar sensing, as multiplexed radar transmitters should not only transmit over different beam directions, but also such beam directions should not point towards a radar receiver).

In some examples, a UE 115 may provide such information to the network entity via an uplink signal (e.g., a scheduling request). A scheduling request for uplink transmissions may include, for example, a buffer status, which may be relevant to uplink signaling but irrelevant to radar sensing (e.g., which does not utilize any buffered data). In such examples, such as UE 115 may transmit an uplink message including the relevant information for the network entity 105-a to schedule radar sensing (e.g., a message transmitted to the network entity 105-a, which may be referred to as a scheduling request, a radar sensing scheduling request, or a radar sensing request, among other examples, and may be included in a message such as a scheduling request, or a random access message, among other examples). For instance, the UE 115 may transmit a scheduling request that includes one or more parameter values, such as a transmit beam direction and/or beamwidth, position and beam orientation of a radar receiver, or any other parameter values.

In some examples, as described herein, beam multiplexing (e.g., beam directions) may refer to one or more dimensions (e.g., an azimuth dimension, an elevation plane, or any combination thereof). As described herein, multiplexing radar sensing may include spatially multiplexing radar sensing on time frequency resources that at least partially overlap with time frequency resources for uplink signaling, downlink signaling, sidelink signaling, or any combination thereof.

In some examples, the UE 115 may transmit the scheduling request including an indication of one or more transmit beams for radar sensing, and the UE 115 may indicate the one or more transmit beams with reference to a coordinate system (e.g., global coordinate reference system). To spatially multiplex radar transmitters, the network entity 105-a may rely on information indicating an absolute beam direction or directions that each radar transmitter is intending to use (e.g., with reference to a global coordinate reference system, as opposed to network entity and UE beam management for uplink signaling, where beam direction is defined relative to the other device). The UE may transmit a scheduling request that indicates the radar sensing transmit beam with reference to the global coordinate reference system that is pre-defined. Each beam direction may correspond to a broadside of a radar sensing transmit beam.

The scheduling request may indicate how much each beam extends from the broadside (e.g., a beamwidth). The beamwidth definition may be pre-defined (e.g., included in one or more standards documents, preconfigured by the network, or any combination thereof). For example, a bandwidth may be defined as a set of angles over which a beam pattern gain is no smaller than a value X number of dB from a threshold gain achieved over a broadside direction (e.g., X=3 or X=10). In some examples, a bandwidth may be defined as a set of angels over which a threshold percent X of a total radiated power on the transmit beam is contained (e.g., X=90 or X=99). In some examples, a bandwidth may be defined as a set of angles for which the total radiated power over other angles is less than a threshold X dBM (e.g., X=−40).

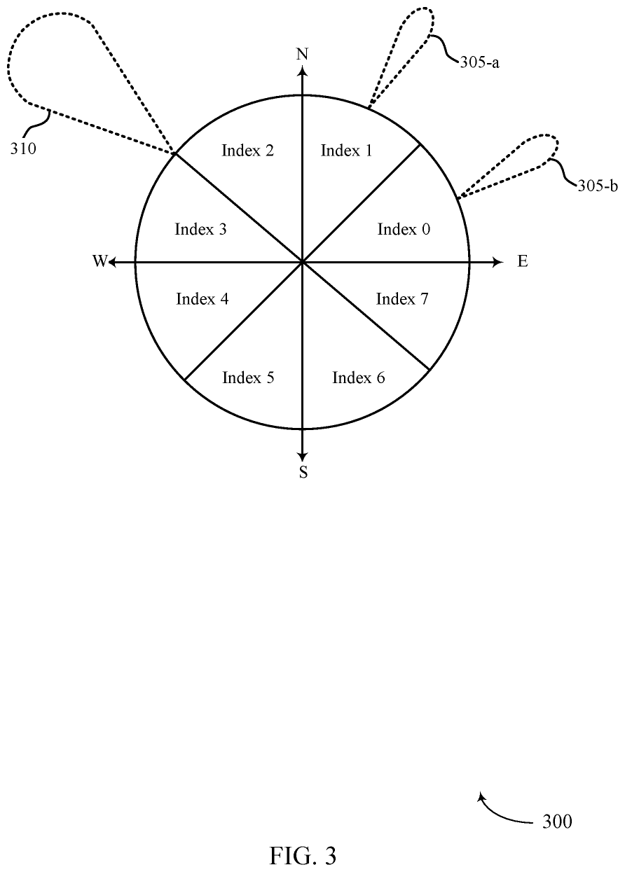

In some examples, a UE 115 may indicate (e.g., in the scheduling request) a direction of one or more beams with reference to the universal or global (e.g., fixed or predetermined) coordinate system, as described in greater detail with reference to FIG. 3.

FIG. 3 illustrates an example of a beam information scheme 300 that supports scheduling requests for spatial multiplexing in accordance with one or more aspects of the present disclosure. Beam information scheme 300 may be implemented by, or may implement, aspects of wireless communications system 100 or wireless communications system 200. For example, a UE (e.g., a UE 115) may transmit a scheduling request to a network entity (e.g., a network entity 105) indicating a beam direction for one or more radar sensing transmit beams. Such UEs and network entities may be examples of corresponding devices described with reference to FIGS. 1 and 2.

In some examples, a UE may indicate (e.g., in an uplink message such as a scheduling request) a radar sensing transmit beam direction (e.g., a beam broadside direction) or beam width as a set of one or more real numbers. The UE may indicate the beam directions or beamwidths or both using real numbers up to a resolution supported by a number of bits allocated to corresponding fields of the uplink message).

In some examples, as illustrated in FIG. 3, the UE may indicate the beam directions or beamwidths or both by indicating values from a pre-configured look-up table (LUT) or multiple pre-configured LUTs. For instance, a scheduling request may indicate an index that points to a pair of broadside direction and beamwidth. In such examples, the network may provide (e.g., via a network entity) a single lookup table indicating a beam direction and a beamwidth associated with each index of a set of indices. To indicate a particular beam and corresponding beam width for that beam, the UE may include the index that corresponds to the selected beam direction and beamwidth (e.g., may jointly encode both the beam direction and the beamwidth using a single index from a single LUT). Similarly, a single index may be associated with a beam direction in multiple dimensions (e.g., or different LUTs may be associated with different dimensions).

In some examples, the scheduling request may indicate multiple (e.g., two) indices, one index pointing to the broadside direction of a radar sensing transmit beam and another index pointing to a beamwidth for the radar sensing transmit beam. For example, the network may configure the UE with a first LUT associated with beam direction, and a second LUT associated with beamwidth. In such examples, the UE may indicate (e.g., in the scheduling request) a beam direction for each of a set of one or more radar sensing transmit beams using an index from the first LUT, and may indicate a beamwidth for each indicated radar sensing transmit beam using an index from the second LUT.

Each index associated with a beam direction may correspond to a pre-configured (e.g., fixed) set of beam directions and beamwidths, as illustrated in FIG. 3. For instance, a 360 degree space may be partitioned into a number of beams (e.g., 8 beams 305, one beam 305 associated with each of indices 0 through 7). Each of the beams may be of equal beamwidth. In some examples (e.g., in the case of a single LUT for jointly encoding beam direction and beamwidth), each index may indicate a beam direction and a beamwidth (e.g., index 0 may be associated with beam 305-b and a first beamwidth, index 1 may be associated with beam 305-a and a second beamwidth, which may be the same as or different than the first beamwidth, etc.).

In some examples, a radar sensing transmit beam (e.g., beam 310), may be greater than a pre-configured beamwidth over a particular direction. For example, a beamwidth of beam 310 may be greater than the region indicated by index 2 or index 3. In such examples, the UE may indicate (e.g., in the scheduling request) two (e.g., or more) indexes (e.g., to account for multiple direction-beamwidth pairs that contain the transmit beam 310). For instance, to indicate a beam direction and/or beam-width for beam 310, the UE may include index 2 and index 3 in the scheduling request.

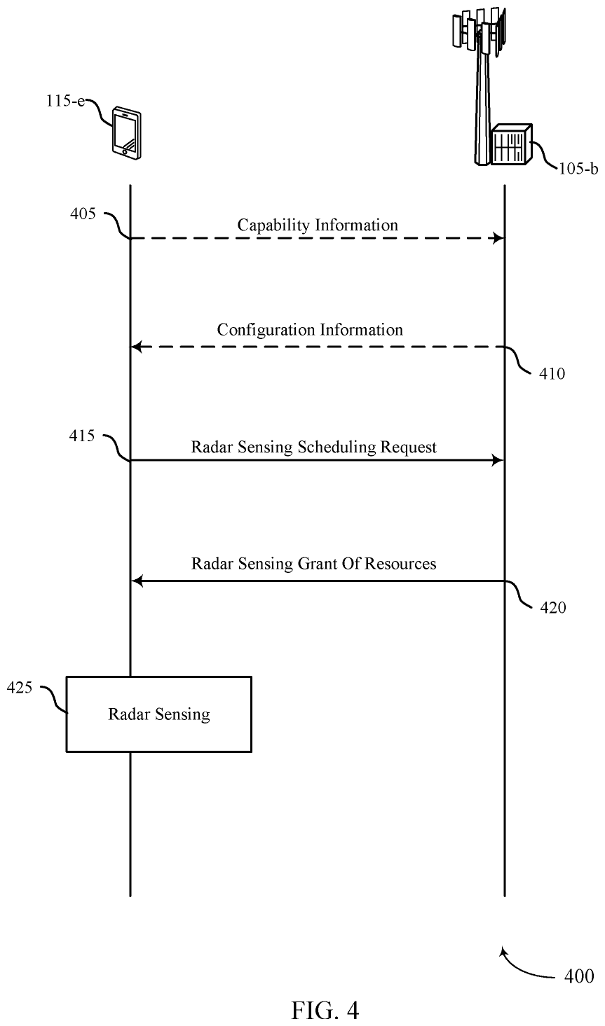

In some examples, a UE may perform radar sensing that includes transmitting radar signaling over multiple different beams (e.g., to identify objects, to track objects of interest, etc.). In some examples, the UE may transmit different types of signaling via different beams. For instance, the UE may transmit uplink signals using one beam, and may transmit radar signaling at a different direction (e.g., using a same signal to probe at a different direction than the network entity) for radar sensing. In such examples, the UE may indicate (e.g., in the scheduling request) attributes or parameters (e.g., beam direction, beamwidth, etc.) for all beams that the UE will use for all types of traffic signaling. For example, the UE may indicate beam attributes for beam 305-a (e.g., index 1) for uplink signaling, and may indicate beam attributes for beam 305-b (e.g., index 0) for radar sensing. In some examples, as described in greater detail with reference to FIG. 4, the UE may indicate a set of beam indices for beam sweeping, or a sequence of beams for beam sweeping (e.g., may indicate index 0 and index 1, or may indicate index 6, index 7, index 0, and index 1 in a specific order for a radar sensing beam sweeping procedure from the direction south(S) to the direction north (N), among other examples).

FIG. 4 illustrates an example of a process flow 400 that supports scheduling requests for spatial multiplexing in accordance with one or more aspects of the present disclosure. Process flow 400 may include a UE 115-e, and a network entity 105-b, which may be examples of corresponding devices described with reference to FIGS. 1-3. The techniques described with reference to process flow 400 may be performed in any order or sequence.

As described herein, a UE may transmit an uplink including an indication of one or more parameter values that the UE will use for radar sensing. Techniques described herein may refer to a scheduling request (e.g., transmitted at 415), but the described techniques may be applied to any uplink message (e.g., a random access message, a scheduling request message, a reporting message, or any other uplink signal). For instance, at 415, the UE 115-e may transmit a radar sensing scheduling request. The scheduling request may include an indication of a set of one or more radar sensing transmit beams (e.g., that the UE 115-e will use to perform radar sensing at 425, or that the UE 115-e is requesting for use at 425, etc.), an indication of one or more beamwidth values for respective ones of the one or more radar sensing transmit beams, or an angular area of interest, among other examples.

In some examples, the UE 115-e may also include, in the radar sensing scheduling request, a threshold bandwidth for transmitting the one or more radar signals, a threshold time duration for transmitting the one or more radar signals, a threshold transmit power for transmitting the one or more radar signals, an indication of a position of the UE 115-e, an indication of a position of a radar receiver, or any combination thereof. For example, the UE 115-e may include, in the radar sensing scheduling request, a preferred (e.g., requested) or threshold bandwidth for transmission, or both. For instance, any bandwidth below a threshold bandwidth may be considered useless. In some examples, the UE 115-e may include, in the radar sensing scheduling request, an indication of a preferred (e.g., requested) or threshold duration for transmissions, or both. The duration may be indicated as a number of OFDM symbols, a number of slots or mini-slots, or an absolute time (e.g., in seconds), among other examples.

In some examples, the UE 115-e may include, in the radar sensing scheduling request, an indication of a preferred (e.g., requested) transmit power, a threshold transmit power, or both. The UE 115-e may indicate such information in terms of an absolute number (e.g., in Watts), an index to a pre-configured lookup table entry (e.g., a LUT configured at 410, where each entry in the LUT corresponds to a power value), a power headroom report, or any combination thereof.

In some examples, the UE 115-e may include an indication of its position, or other location information, in the radar sensing scheduling request (e.g., if the network entity 105-b does not already have access to position information for the UE 115-e). For instance, the UE 15-e may request a beam pointing North, and a second UE 115 may request a beam pointing south. If the UE 115-e is positioned North of the second UE 115, then both UEs 115 may be scheduled to transmit using the requested beams without interfering with each other. However, if the second UE 115 is located North of the UE 115-e, then network may refrain from allocating the same resources to the UE 115-e and the second UE 115 because transmission on the requested beams may result in interference. Thus, the network may more effectively mitigate or ignore interference by having access to location information for UEs 115 (e.g., as indicted in scheduling requests).

Having transmitted the radar sensing scheduling request at 415, the UE 115-e may receive a radar sensing grant of resources at 420 for radar sensing (e.g., via a DCI message, a MAC-CE, or RRC signaling). In some examples, the UE 115-e may receive the radar sensing grant of resources from the network entity 105-b (e.g., or any other network entity, which may or may not be the same network entity 105 to which the UE 115-e transits the radar sensing scheduling request at 415). The radar sensing grant of resources may indicate time frequency resources on which the UE 115-e may perform radar sensing at 425. The resources may be allocated such that the UE 115-e is sharing the time frequency resources with other UEs 115 performing uplink signaling, downlink signaling, sidelink signaling, or any combination thereof (e.g., the UE 115-e is spatially multiplexed based on information included in the radar sensing scheduling request at 415). The UE may then perform radar sensing at 425 at 425 (e.g., may transmit radar signals according to the radar sensing grant of resources using beams pointed in directions that do not interfere with uplink signaling from other UEs 115 to the network entity 105-b, do not interfere with sidelink communications between other UEs 115, downlink signaling to other UEs 115, or any combination thereof).

The UE 115-e may indicate information, such as information about radar transmitters, radar receivers, transmit beams, or receive beams, using real numbers, or indices associated with one or more LUTs, as described in greater detail with reference to FIG. 3. In some examples, the UE 115-e may receive (e.g., from the network entity 105-b) control information, such as configuration information (e.g., RRC signaling). The configuration information may include an indication of one or more relationships (e.g., one or more LUTs). For example, the control signaling may include an indication of a relationship between a set of indices, respective radar sensing transmit beams of a set of radar sensing transmit beams, and respective beamwidth values of a set of beamwidth values (e.g., a first LUT for joint encoding). In some examples, the control signaling may include an indication of a first relationship between a first set of indices and respective radar sensing transmit beams (e.g., a first LUT) and an indication of a second relationship between a second set of indices and respective beamwidth values of a set of beamwidth values (e.g., a second LUT). In some examples, the radar sensing scheduling request may indicate a beam sequence (e.g., and corresponding beam durations), which may be restricted to those contained in a pre-configured table (e.g., LUT), and the indication in the radar sensing scheduling request may point to an appropriate table entry or entries.

In such examples, the UE 115-e may include, in the radar sensing scheduling request, one or more index values associated with the one or more LUTs in the radar sensing scheduling request. In some examples, transmit beams and receive beams (e.g., for a radar transmitter and a radar receiver) may be indicated together (e.g., may be jointly encoded via a single index indicating both a transmit beam and a receive beam via a single LUT). In some examples, transmit beam information (e.g., transmit beam directions, transmit beam beamwidths, etc.) may be indicated via a first set of one or more LUTs, and receive beam information (e.g., receiver location, receive beam direction, receive beam beamwidths, etc.) may be indicated via a first set of one or more LUTs. In some examples, beam sequences or beam orders may be indicated via an index of a LUT (e.g., a LUT that indicates sequences or orders of available beams), or may be indicated via a set of indices (e.g., to sweep through four beams the UE 115-e or the network entity 105-b may indicate four beam indices associated with one or more LUTs).

In some examples, the UE 115-e may transmit capability information at 405. The capability information may include an indication that the UE 115-e is capable of supporting radar sensing and other traffic (e.g., uplink signaling, downlink signaling, sidelink signaling, etc.). Radar sensing may be performed during different times (e.g., slots) than uplink signaling, or may be performed simultaneously with other traffic (e.g., which the UE 115-e may indicate in the capability information). In some examples, the capability information may further include such examples as beam directions or beamwidths that the UE 115-e may support, or angular areas of interest that the UE 115-e may scan. In some examples, the network entity 105-b may transmit the configuration information at 410 based on the UE 115-e transmitting capability information at 405.

The UE 115-e may perform monostatic radar sensing, or bistatic (e.g., cooperative) radar sensing. If the UE 115-e performs monostatic radar sensing at 425, a radar transmitter and radar receiver may be collocated at the UE 115-e. In such examples, the receiver position coincides with the transmitter position, and the UE 115-e may not include any additional receiver information in the radar sensing scheduling request transmitted at 415. For monostatic analog receiver beamforming, a receive beam (e.g., a receive beam direction, a receive beam beamwidth, etc.) may coincide with a transmit beam, and the UE 115-e may not separately indicate transmit and receive beams and beamwidth values. In some examples, the network entity 105-b may assume that a transmit beam and receive beam (e.g., and transmit beamwidths and receive beamwidths) coincide if the radar sensing scheduling request does not indicate otherwise (e.g., does not include a separate indication for receive beam information in the radar sensing scheduling request). However, if the UE performs bistatic (e.g., cooperative) radar sensing, a radar transmitter and radar receiver may not be collocated (e.g., two UEs 115 may cooperate to perform radar sensing at 425).

In such examples, the UE 115-e may include information regarding the receiver position, beam direction, beamwidth, etc., in the radar sensing scheduling request transmitted at 415. For example, the UE 115-e may include, in the radar sensing scheduling request, an indication of a receiver position (e.g., a location of the radar receiver, or a location or identifier of a UE 115, network entity 105, that will be acting as the receiver for cooperative radar sensing). The UE 115-e may indicate the location of a receiver by indicating global positioning system (GPS) coordinates, zone identifiers (e.g., sidelink zone identifiers, an indication of a location with reference to a grid system, etc.), or an indication of a device identifier associated with the radar sensing receiver (e.g., and the network entity 105-b may determine or already have access to information related to the location of the identified receiver). For monostatic digital receive beamforming, or for bistatic radar sensing detections, receive beams and transmit beams may be different than each other, and the UE 115-e may indicate transmit beam information and receive beam information, as described herein (e.g., via one or more LUTs, as described in greater detail with reference to FIG. 3).

The UE 115-e may perform radar sensing at 425 by scanning an angular area (e.g., a wide angular range). The UE 115-e may perform beam sweeping during a transmission burst to scan the angular area. In such examples, the UE 115-e may include, in the radar sensing scheduling request, an indication of a sequence of transmit beams, receive beams, or both, a duration during which each beam will be active (e.g., a CPI for each beam, an amount of time for each beam, an integer number of OFDM symbols, an integer number of slots, or a number of any other transmission time interval (TTI)). The beam sequence (e.g., and beam durations) may be specific (e.g., the UE 115-e may indicate indices 0 through 3 to indicate a 180 degree sweep from East (E) to West (W)). In some examples, the beam sequence may be arbitrary. The UE 115-e may indicate the beam sequence explicitly in the radar sensing scheduling request.

In some examples, the UE 115-e may perform general purpose radar sensing or radar scanning (e.g., may not be tracking a specific target or sweeping using a particular sequence), and the UE 115-e may have no preference regarding sequence or ordering of beams that it will sweep over to cover an angular region of interest. In such examples, the UE 115-e may successfully perform radar sensing by transmitting radar signals on each beam of a set of beams associated with the angular area of interest, but a sequence or order of the beams may have no impact on the radar sensing. In such examples, the network (e.g., the network entity 105-b) may determine a beam sweeping sequence over an area of interest (e.g., to minimize interference with other ongoing transmission. In such examples, the UE 115-e may transmit, in the radar sensing scheduling request, an indication of an angular region of interest. In some examples, the UE 115-e may indicate that the angular region of interest in terms of a number of degrees from a particular direction, or a range of degrees (e.g., 10 degrees left from N, or up to 10 degrees left of N), or as a set of indices indicating beam directions.

In some examples, the UE may indicate a sequence of transmit beams in terms of an index from a LUT indicating a preconfigured sequence of available beams. The index may be jointly encoded with other information (e.g., a single LUT indicating beamwidths, beam sequences, etc.), or individually encoded (e.g., a first index indicating a beam sequence from a LUT of beam sequences, a second index indicating timing or beamwidth values, etc.). The UE 115-e may indicate a duration for each transmit beam (e.g., a CPI), or a beam direction that the radar transmitter can support and corresponding beamwidth. In response, the network entity 105-b may transmit the radar sensing grant of resources at 420, which may indicate a sequence of beams to use for scanning the angular region of interest (e.g., to avoid interference with traffic on the same time frequency resources).

In some examples, the UE 115-e may transmit, in the radar sensing scheduling request, an indication of one or more requested beams (e.g., a single radar sensing transmit beam, or a sequence of beams). The network entity 105-b may determine whether the requested beams are available (e.g., whether the requested beam or beam sequence will result in interference with other traffic on the time frequency resources). The network entity 105-b may transmit, in the radar sensing grant of resources, an indication of one or more beams for performing radar sensing at 425. The indicated one or more beams may be the same one or more beams requested by the UE 115-e at 415, or may be a subset of the requested one or more beams, or may be entirely different (e.g., depending on availability, predicted interference, etc., as determined by the network entity 105-b). In some examples, the network entity 105-b may determine that one or more of the requested beams are unavailable, but may select one or more beams for radar sensing based on the requested beams (e.g., may identify one or more next-best beams, or beams that are close or similar to the requested one or more beams).

As described herein, an enhanced or additional radar sensing scheduling request for radar transmissions may occur over uplink or sidelink resources (e.g., mode 1 sidelink resources). Such a radar sensing scheduling request may include information used by the network entity 105-b to identify opportunities for spatial multiplexing of UEs 115 (e.g., including the UE 115-e) to achieve improved resource efficiency and reliable radar sensing. Techniques described herein describe how the UE 115-e may indicate (e.g., in the radar sensing scheduling request at 415) radar sensing transmit beams, radar sensing receive beams, sequences of radar sensing beams (e.g., transmit beams or receive beams or both) for radar scanning.

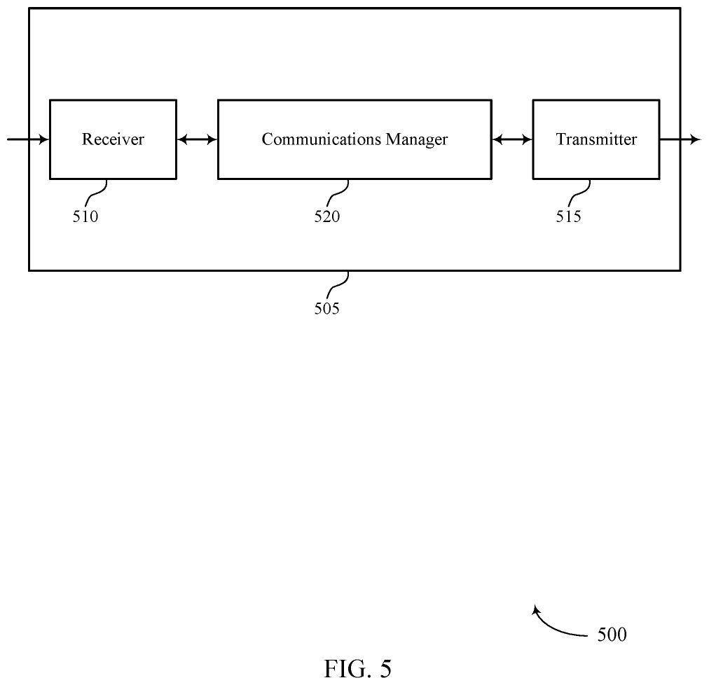

FIG. 5 shows a block diagram 500 of a device 505 that supports scheduling requests for spatial multiplexing in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to scheduling requests for spatial multiplexing). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to scheduling requests for spatial multiplexing). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of scheduling requests for spatial multiplexing as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for transmitting a scheduling request including one or more of: an indication of a set of one or more radar sensing transmit beams, an indication of one or more beamwidth values for respective ones of the one or more radar sensing transmit beams, or an angular area of interest for radar sensing. The communications manager 520 may be configured as or otherwise support a means for receiving a control message indicating a grant of resources on a physical shared channel based on transmitting the scheduling request. The communications manager 520 may be configured as or otherwise support a means for transmitting one or more radar signals according to the grant of resources on the physical shared channel.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for signaling to support radar sensing resulting in more efficient use of computational resources, improved efficiency of radar sensing, decreased interference resulting in increased reliability of wireless communications, improved safety features, decreased system latency, and improved user experience.

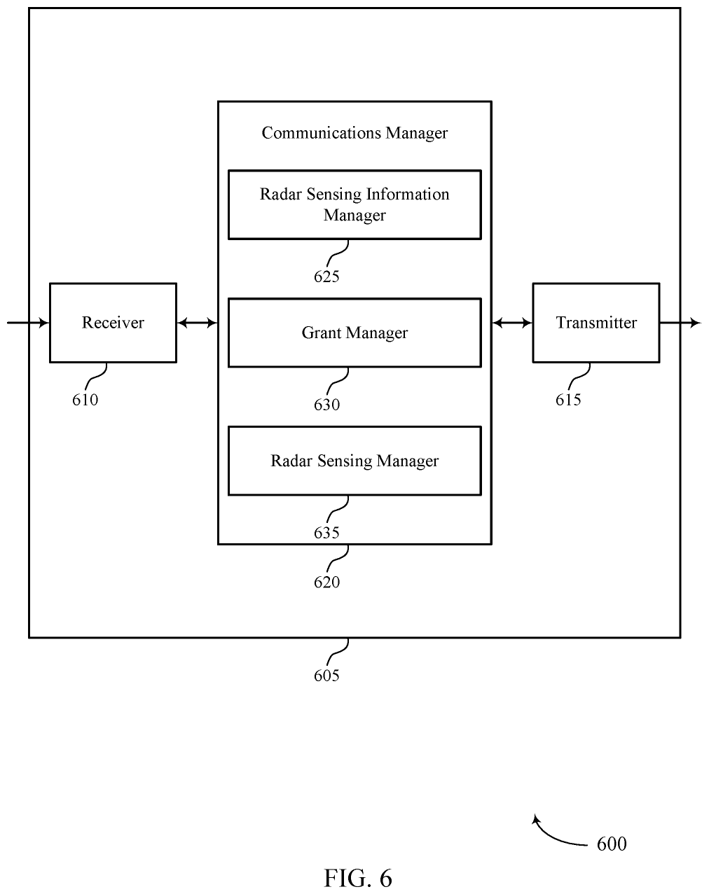

FIG. 6 shows a block diagram 600 of a device 605 that supports scheduling requests for spatial multiplexing in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling requests for spatial multiplexing). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling requests for spatial multiplexing). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of scheduling requests for spatial multiplexing as described herein. For example, the communications manager 620 may include a radar sensing information manager 625, a grant manager 630, a radar sensing manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The radar sensing information manager 625 may be configured as or otherwise support a means for transmitting a scheduling request including one or more of: an indication of a set of one or more radar sensing transmit beams, an indication of one or more beamwidth values for respective ones of the one or more radar sensing transmit beams, or an angular area of interest for radar sensing. The grant manager 630 may be configured as or otherwise support a means for receiving a control message indicating a grant of resources on a physical shared channel based on transmitting the scheduling request. The radar sensing manager 635 may be configured as or otherwise support a means for transmitting one or more radar signals according to the grant of resources on the physical shared channel.

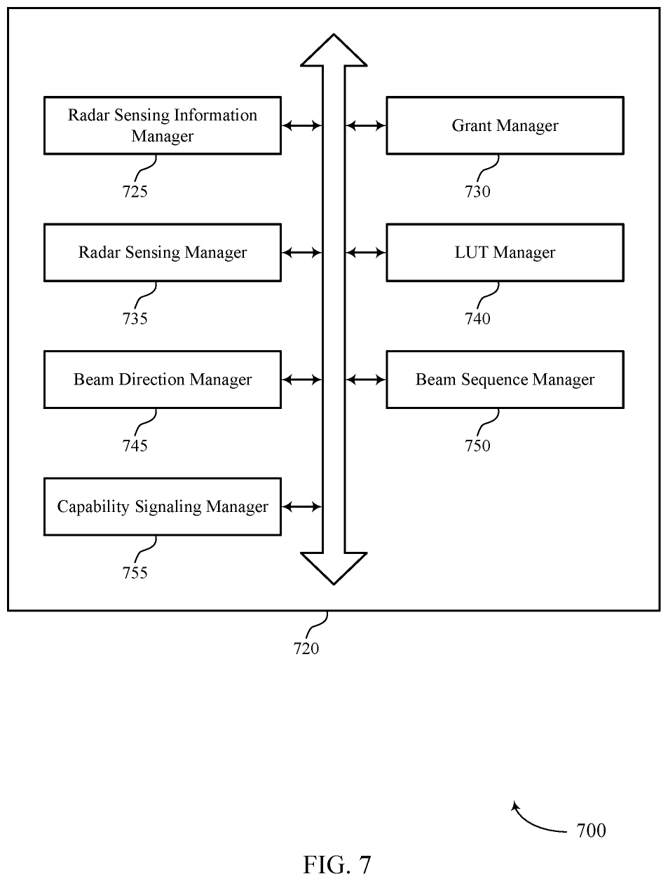

FIG. 7 shows a block diagram 700 of a communications manager 720 that supports scheduling requests for spatial multiplexing in accordance with one or more aspects of the present disclosure. The communications manager 720 may be an example of aspects of a communications manager 520, a communications manager 620, or both, as described herein. The communications manager 720, or various components thereof, may be an example of means for performing various aspects of scheduling requests for spatial multiplexing as described herein. For example, the communications manager 720 may include a radar sensing information manager 725, a grant manager 730, a radar sensing manager 735, a LUT manager 740, a beam direction manager 745, a beam sequence manager 750, a capability signaling manager 755, or any combination thereof. Each of these components may communicate, directly or indirectly, with one another (e.g., via one or more buses).

The communications manager 720 may support wireless communications at a UE in accordance with examples as disclosed herein. The radar sensing information manager 725 may be configured as or otherwise support a means for transmitting a scheduling request including one or more of: an indication of a set of one or more radar sensing transmit beams, an indication of one or more beamwidth values for respective ones of the one or more radar sensing transmit beams, or an angular area of interest for radar sensing. The grant manager 730 may be configured as or otherwise support a means for receiving a control message indicating a grant of resources on a physical shared channel based on transmitting the scheduling request. The radar sensing manager 735 may be configured as or otherwise support a means for transmitting one or more radar signals according to the grant of resources on the physical shared channel.

In some examples, the LUT manager 740 may be configured as or otherwise support a means for receiving control signaling including an indication of a relationship between a set of indices, respective radar sensing transmit beams of a set of multiple radar sensing transmit beams including the set of one or more radar sensing transmit beams, and respective beamwidth values of a set of multiple beamwidth values including the one or more beamwidth values.

In some examples, the LUT manager 740 may be configured as or otherwise support a means for transmitting, in the scheduling request, one or more indices of the set of indices associated with the set of one or more radar sensing transmit beams and the one or more beamwidth values.

In some examples, the capability signaling manager 755 may be configured as or otherwise support a means for transmitting a capability message including an indication that the UE is capable of supporting radar sensing and uplink signaling, where receiving the control signaling is based on transmitting the capability message.

In some examples, the LUT manager 740 may be configured as or otherwise support a means for receiving control signaling including an indication of a first relationship between a first set of indices and respective radar sensing transmit beams of a set of multiple radar sensing transmit beams including the set of one or more radar sensing transmit beams and an indication of a second relationship between a second set of indices and respective beamwidth values of a set of multiple beamwidth values including the one or more beamwidth values.

In some examples, the LUT manager 740 may be configured as or otherwise support a means for transmitting, in the scheduling request, one or more indices of the first set of indices associated with the set of one or more radar sensing transmit beams, and one or more indices of the second set of indices associated with the one or more beamwidth values.

In some examples, the capability signaling manager 755 may be configured as or otherwise support a means for transmitting a capability message including an indication that the UE is capable of supporting simultaneous radar sensing and uplink signaling, where receiving the control signaling is based on transmitting the capability message.

In some examples, to support indication of the set of one or more radar sensing transmit beams, the beam direction manager 745 may be configured as or otherwise support a means for an indication of a direction of each of the one or more radar sensing transmit beams with reference to a coordinate system. In some examples, the direction of each of the set of one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

In some examples, the radar sensing information manager 725 may be configured as or otherwise support a means for transmitting, in the scheduling request, an indication of one or more radar sensing receive beams, an indication of a position of a receiver for cooperative radar sensing, or both. In some examples, the radar sensing information manager 725 may be configured as or otherwise support a means for transmitting, in the scheduling request, an indication of a sequence of the one or more radar sensing transmit beams, a time period associated with radar sensing on each radar sensing transmit beam of the one or more radar sensing transmit beams, or both.

In some examples, the beam sequence manager 750 may be configured as or otherwise support a means for receiving, in the grant of resources based on transmitting the scheduling request including the angular area of interest for radar sensing, an indication of a sequence of the set of one or more radar sensing transmit beams associated with the angular area of interest for radar sensing, where transmitting the one or more radar signals according to the grant of resources on the physical shared channel includes transmitting the one or more radar signals according to the sequence of the set of one or more radar sensing transmit beams.

In some examples, the radar sensing information manager 725 may be configured as or otherwise support a means for receiving, in the grant of resources based on transmitting the scheduling request including the indication of the set of one or more radar sensing transmit beams, an indication of a second set of one or more radar sensing transmit beams associated with the angular area of interest for radar sensing, where transmitting the one or more radar signals according to the grant of resources on the physical shared channel includes transmitting the one or more radar signals using the second set of one or more radar sensing transmit beams. In some examples, the set of one or more radar sensing transmit beams is different from the second set of one or more radar sensing transmit beams.

In some examples, the radar sensing information manager 725 may be configured as or otherwise support a means for transmitting, in the scheduling request, a threshold bandwidth for transmitting the one or more radar signals, a threshold time duration for transmitting the one or more radar signals, a threshold transmit power for transmitting the one or more radar signals, an indication of a position of the UE, or any combination thereof.

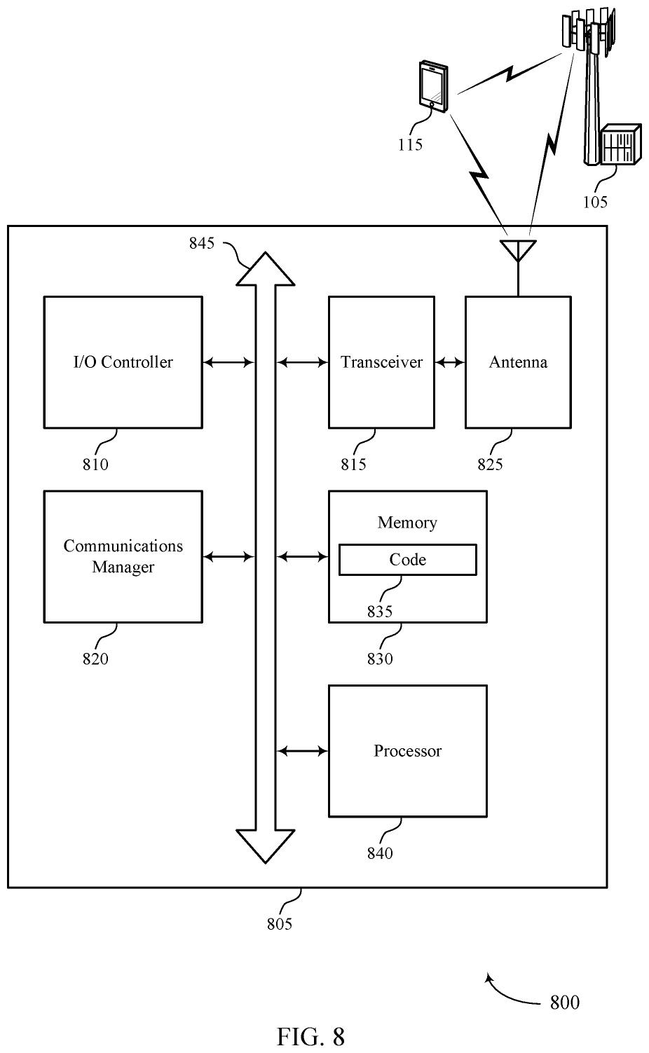

FIG. 8 shows a diagram of a system 800 including a device 805 that supports scheduling requests for spatial multiplexing in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting scheduling requests for spatial multiplexing). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting a scheduling request including one or more of: an indication of a set of one or more radar sensing transmit beams, an indication of one or more beamwidth values for respective ones of the one or more radar sensing transmit beams, or an angular area of interest for radar sensing. The communications manager 820 may be configured as or otherwise support a means for receiving a control message indicating a grant of resources on a physical shared channel based on transmitting the scheduling request. The communications manager 820 may be configured as or otherwise support a means for transmitting one or more radar signals according to the grant of resources on the physical shared channel.

By including or configuring the communications manager 820 in accordance with examples as described herein, the device 805 may support techniques for signaling to support radar sensing resulting in improved efficiency of radar sensing, decreased interference resulting in increased reliability of wireless communications, improved safety features, decreased system latency, reduced power consumption (e.g., resulting from more efficient radar sensing and decreased interference), and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of scheduling requests for spatial multiplexing as described herein, or the processor 840 and the memory 830 may be otherwise configured to perform or support such operations.

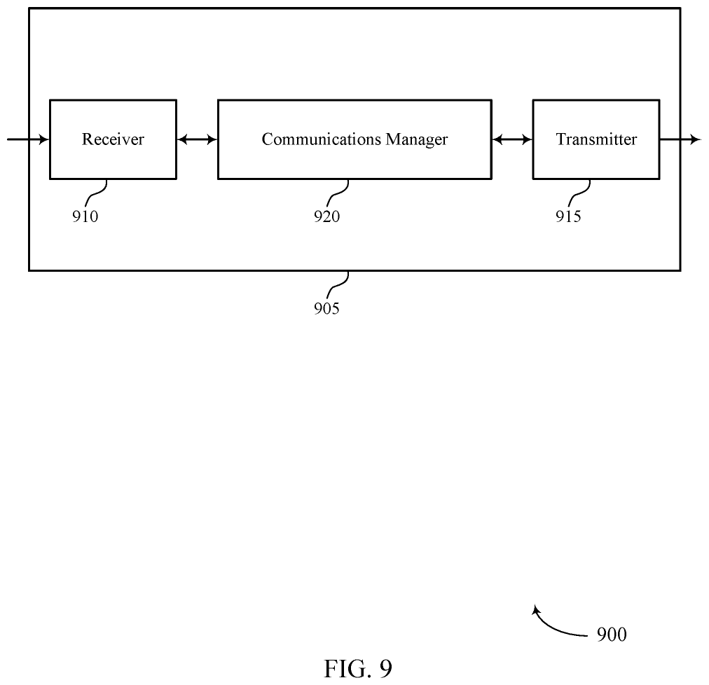

FIG. 9 shows a block diagram 900 of a device 905 that supports scheduling requests for spatial multiplexing in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of scheduling requests for spatial multiplexing as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting control signaling including an indication of a set of multiple radar sensing transmit beams and a set of multiple beamwidth values associated with the set of multiple radar sensing transmit beams. The communications manager 920 may be configured as or otherwise support a means for receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE. The communications manager 920 may be configured as or otherwise support a means for transmitting, based on receiving the scheduling request, a control message indicating a grant of resources for performing radar sensing on a physical shared channel.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for signaling to support radar sensing resulting in more efficient use of computational resources, improved efficiency of radar sensing, decreased interference resulting in increased reliability of wireless communications, improved safety features, decreased system latency, and improved user experience.

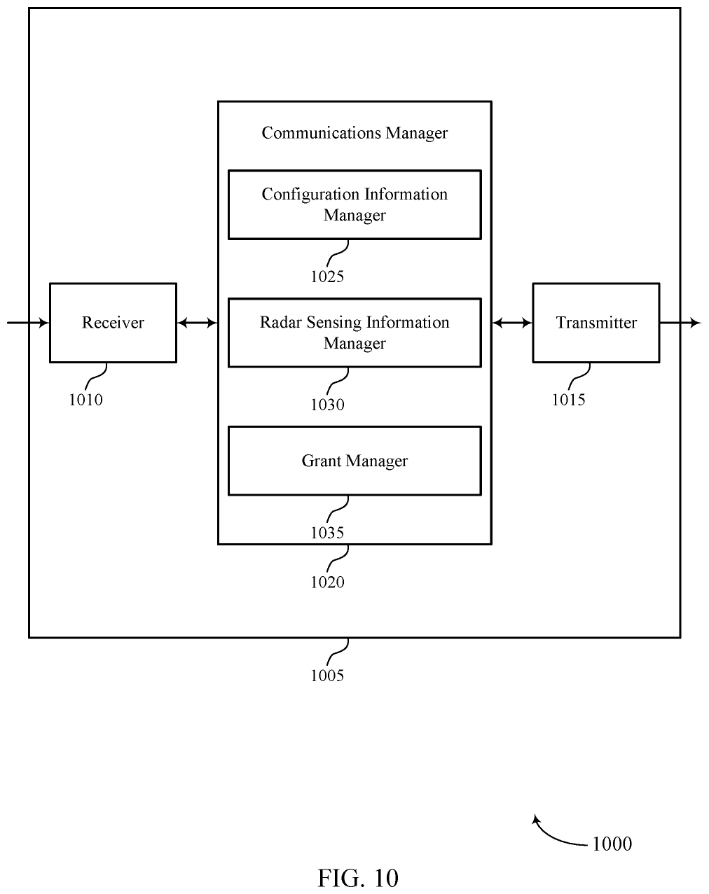

FIG. 10 shows a block diagram 1000 of a device 1005 that supports scheduling requests for spatial multiplexing in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of scheduling requests for spatial multiplexing as described herein. For example, the communications manager 1020 may include a configuration information manager 1025, a radar sensing information manager 1030, a grant manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The configuration information manager 1025 may be configured as or otherwise support a means for transmitting control signaling including an indication of a set of multiple radar sensing transmit beams and a set of multiple beamwidth values associated with the set of multiple radar sensing transmit beams. The radar sensing information manager 1030 may be configured as or otherwise support a means for receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE. The grant manager 1035 may be configured as or otherwise support a means for transmitting, based on receiving the scheduling request, a control message indicating a grant of resources for performing radar sensing on a physical shared channel.

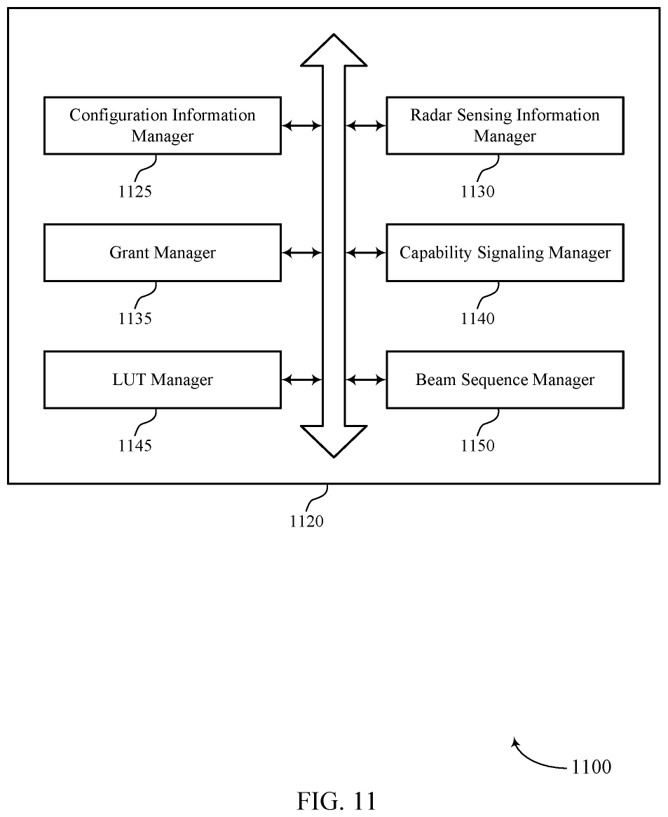

FIG. 11 shows a block diagram 1100 of a communications manager 1120 that supports scheduling requests for spatial multiplexing in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of scheduling requests for spatial multiplexing as described herein. For example, the communications manager 1120 may include a configuration information manager 1125, a radar sensing information manager 1130, a grant manager 1135, a capability signaling manager 1140, a LUT manager 1145, a beam sequence manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The configuration information manager 1125 may be configured as or otherwise support a means for transmitting control signaling including an indication of a set of multiple radar sensing transmit beams and a set of multiple beamwidth values associated with the set of multiple radar sensing transmit beams. The radar sensing information manager 1130 may be configured as or otherwise support a means for receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE. The grant manager 1135 may be configured as or otherwise support a means for transmitting, based on receiving the scheduling request, a control message indicating a grant of resources for performing radar sensing on a physical shared channel.

In some examples, the capability signaling manager 1140 may be configured as or otherwise support a means for receiving a capability message including an indication that the UE is capable of supporting simultaneous radar sensing and uplink signaling, where transmitting the control signaling is based on receiving the capability message.

In some examples, to support transmitting the control signaling, the LUT manager 1145 may be configured as or otherwise support a means for transmitting an indication of a relationship between a set of indices, respective radar sensing transmit beams of the set of multiple radar sensing transmit beams, and respective beamwidth values of the set of multiple beamwidth values.

In some examples, the LUT manager 1145 may be configured as or otherwise support a means for receiving, in the scheduling request, one or more indices of the set of indices associated with the set of one or more radar sensing transmit beams and the one or more beamwidth values.

In some examples, to support transmitting the control signaling, the LUT manager 1145 may be configured as or otherwise support a means for transmitting an indication of a first relationship between a first set of indices and respective radar sensing transmit beams of the set of multiple radar sensing transmit beams and an indication of a second relationship between a second set of indices and respective beamwidth values of the set of multiple beamwidth values.

In some examples, the LUT manager 1145 may be configured as or otherwise support a means for receiving, in the scheduling request, one or more indices of the first set of indices associated with the set of one or more radar sensing transmit beams, and one or more indices of the second set of indices associated with the one or more beamwidth values.

In some examples, to support indication of the set of one or more radar sensing transmit beams, the configuration information manager 1125 may be configured as or otherwise support a means for an indication of a direction of each of the one or more radar sensing transmit beams with reference to a coordinate system.

In some examples, the direction of each of the one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

In some examples, the radar sensing information manager 1130 may be configured as or otherwise support a means for receiving, in the scheduling request, an indication of one or more radar sensing receive beams, an indication of a position of a receiver for cooperative radar sensing, or both.

In some examples, the beam sequence manager 1150 may be configured as or otherwise support a means for receiving, in the scheduling request, an indication of a sequence of the one or more radar sensing transmit beams, a time period associated with radar sensing on each radar sensing transmit beam of the one or more radar sensing transmit beams, or both.

In some examples, the configuration information manager 1125 may be configured as or otherwise support a means for identifying, based on receiving the scheduling request including the indication of the angular area of interest for radar sensing, a sequence of the set of one or more radar sensing transmit beams that satisfies an interference threshold associated with uplink signaling, radar sensing, or both, within the angular area of interest. In some examples, the grant manager 1135 may be configured as or otherwise support a means for transmitting, in the grant of resources, an indication of the sequence of the set of one or more radar sensing transmit beams.

In some examples, the radar sensing information manager 1130 may be configured as or otherwise support a means for identifying, based on receiving the scheduling request including the indication of the set of one or more radar sensing transmit beams, a second set of one or more radar sensing transmit beams that are available for radar sensing by the UE. In some examples, the radar sensing information manager 1130 may be configured as or otherwise support a means for transmitting, in the grant of resource, an indication of the second set of one or more radar sensing transmit beams.

In some examples, the configuration information manager 1125 may be configured as or otherwise support a means for receiving, in the scheduling request, a threshold bandwidth for transmitting one or more radar signals, a threshold time duration for transmitting each of the one or more radar signals, a threshold transmit power for transmitting the one or more radar signals, or any combination thereof.

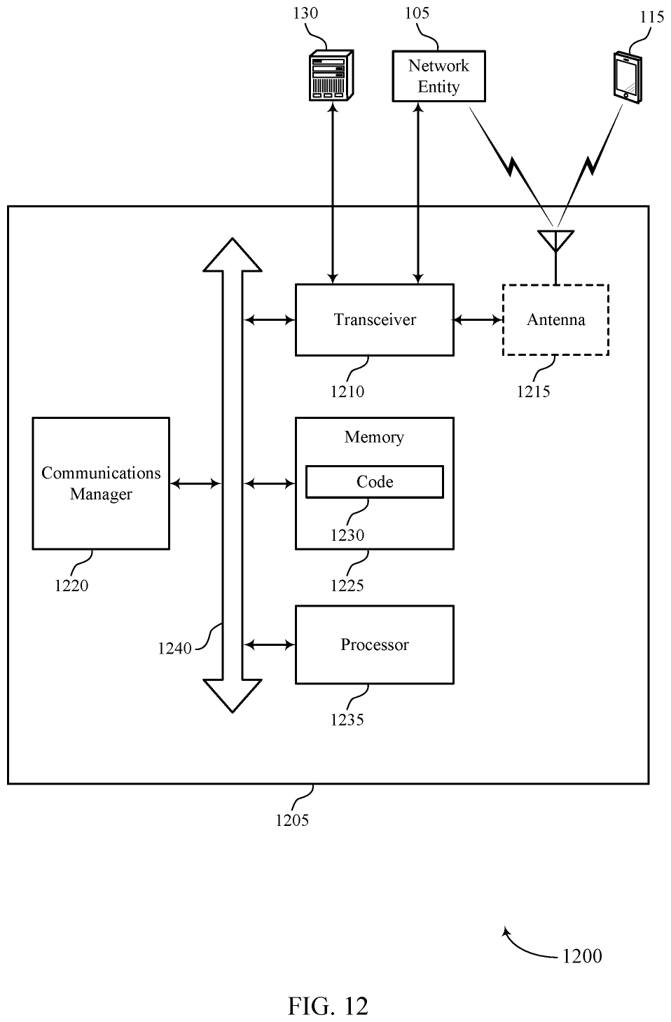

FIG. 12 shows a diagram of a system 1200 including a device 1205 that supports scheduling requests for spatial multiplexing in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting scheduling requests for spatial multiplexing). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting control signaling including an indication of a set of multiple radar sensing transmit beams and a set of multiple beamwidth values associated with the set of multiple radar sensing transmit beams. The communications manager 1220 may be configured as or otherwise support a means for receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE. The communications manager 1220 may be configured as or otherwise support a means for transmitting, based on receiving the scheduling request, a control message indicating a grant of resources for performing radar sensing on a physical shared channel.

By including or configuring the communications manager 1220 in accordance with examples as described herein, the device 1205 may support techniques for signaling to support radar sensing resulting in improved efficiency of radar sensing, decreased interference resulting in increased reliability of wireless communications, improved safety features, decreased system latency, reduced power consumption (e.g., resulting from more efficient radar sensing and decreased interference), and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of scheduling requests for spatial multiplexing as described herein, or the processor 1235 and the memory 1225 may be otherwise configured to perform or support such operations.

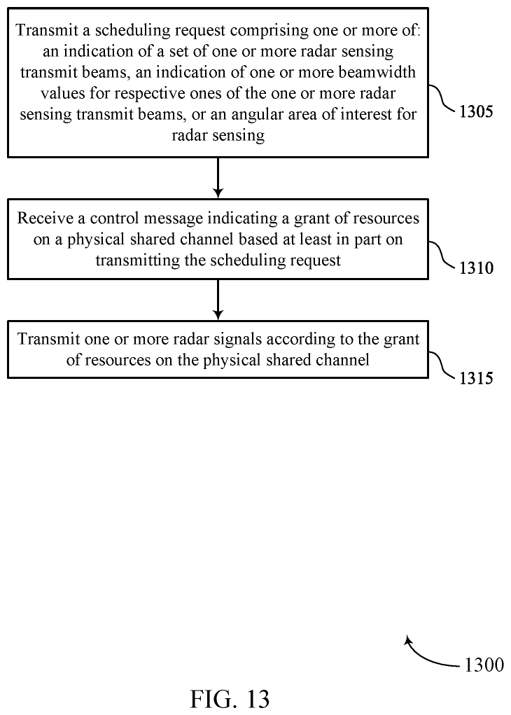

FIG. 13 shows a flowchart illustrating a method 1300 that supports scheduling requests for spatial multiplexing in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a scheduling request including one or more of: an indication of a set of one or more radar sensing transmit beams, an indication of one or more beamwidth values for respective ones of the one or more radar sensing transmit beams, or an angular area of interest for radar sensing. The operations of 1305 may be performed in accordance with examples as disclosed herein. In some examples, aspects of the operations of 1305 may be performed by a radar sensing information manager 725 as described with reference to FIG. 7.

At 1310, the method may include receiving a control message indicating a grant of resources on a physical shared channel based on transmitting the scheduling request. The operations of 1310 may be performed in accordance with examples as disclosed herein. In some examples, aspects of the operations of 1310 may be performed by a grant manager 730 as described with reference to FIG. 7.

At 1315, the method may include transmitting one or more radar signals according to the grant of resources on the physical shared channel. The operations of 1315 may be performed in accordance with examples as disclosed herein. In some examples, aspects of the operations of 1315 may be performed by a radar sensing manager 735 as described with reference to FIG. 7.

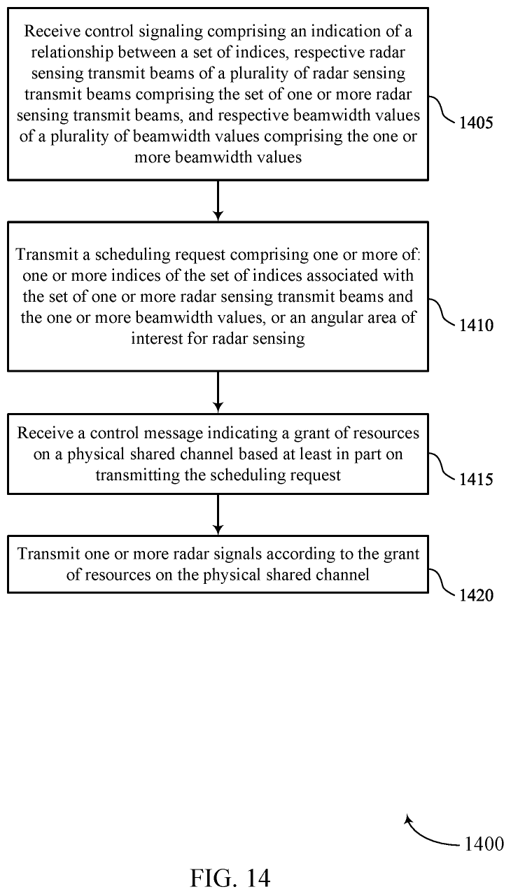

FIG. 14 shows a flowchart illustrating a method 1400 that supports scheduling requests for spatial multiplexing in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling including an indication of a relationship between a set of indices, respective radar sensing transmit beams of a set of multiple radar sensing transmit beams including the set of one or more radar sensing transmit beams, and respective beamwidth values of a set of multiple beamwidth values including the one or more beamwidth values. The operations of 1405 may be performed in accordance with examples as disclosed herein. In some examples, aspects of the operations of 1405 may be performed by a LUT manager 740 as described with reference to FIG. 7.

At 1410, the method may include transmitting a scheduling request including one or more of: one or more indices of the set of indices associated with the set of one or more radar sensing transmit beams and the one or more beamwidth values, or an angular area of interest for radar sensing. The operations of 1410 may be performed in accordance with examples as disclosed herein. In some examples, aspects of the operations of 1410 may be performed by a radar sensing information manager 725 as described with reference to FIG. 7.

At 1415, the method may include receiving a control message indicating a grant of resources on a physical shared channel based on transmitting the scheduling request. The operations of 1415 may be performed in accordance with examples as disclosed herein. In some examples, aspects of the operations of 1415 may be performed by a grant manager 730 as described with reference to FIG. 7.

At 1420, the method may include transmitting one or more radar signals according to the grant of resources on the physical shared channel. The operations of 1420 may be performed in accordance with examples as disclosed herein. In some examples, aspects of the operations of 1420 may be performed by a radar sensing manager 735 as described with reference to FIG. 7.

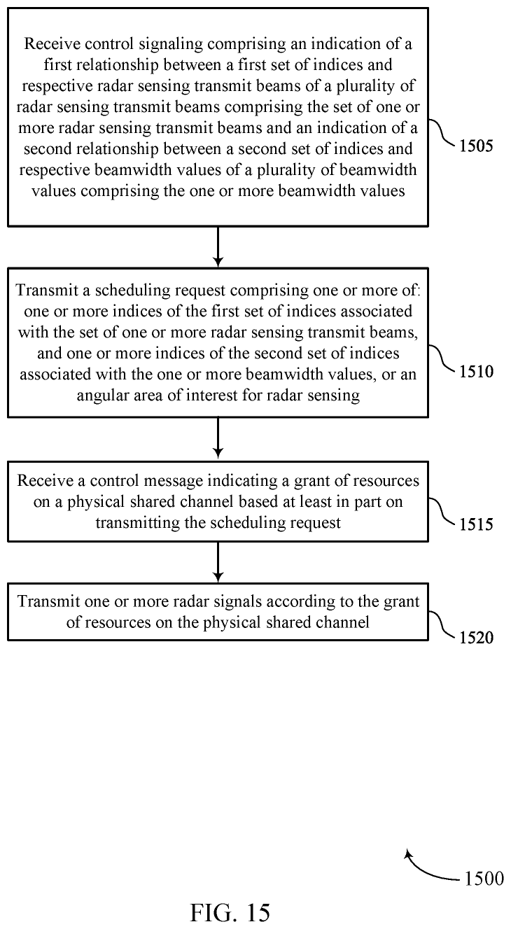

FIG. 15 shows a flowchart illustrating a method 1500 that supports scheduling requests for spatial multiplexing in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving control signaling including an indication of a first relationship between a first set of indices and respective radar sensing transmit beams of a set of multiple radar sensing transmit beams including the set of one or more radar sensing transmit beams and an indication of a second relationship between a second set of indices and respective beamwidth values of a set of multiple beamwidth values including the one or more beamwidth values. The operations of 1505 may be performed in accordance with examples as disclosed herein. In some examples, aspects of the operations of 1505 may be performed by a LUT manager 740 as described with reference to FIG. 7.

At 1510, the method may include transmitting a scheduling request including one or more of: one or more indices of the first set of indices associated with the set of one or more radar sensing transmit beams, and one or more indices of the second set of indices associated with the one or more beamwidth values, or an angular area of interest for radar sensing. The operations of 1510 may be performed in accordance with examples as disclosed herein. In some examples, aspects of the operations of 1510 may be performed by a radar sensing information manager 725 as described with reference to FIG. 7.

At 1515, the method may include receiving a control message indicating a grant of resources on a physical shared channel based on transmitting the scheduling request. The operations of 1515 may be performed in accordance with examples as disclosed herein. In some examples, aspects of the operations of 1515 may be performed by a grant manager 730 as described with reference to FIG. 7.

At 1520, the method may include transmitting one or more radar signals according to the grant of resources on the physical shared channel. The operations of 1520 may be performed in accordance with examples as disclosed herein. In some examples, aspects of the operations of 1520 may be performed by a radar sensing manager 735 as described with reference to FIG. 7.

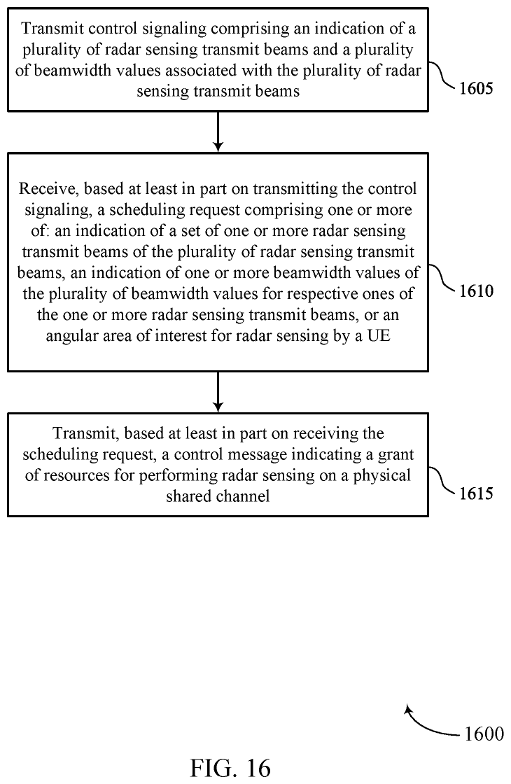

FIG. 16 shows a flowchart illustrating a method 1600 that supports scheduling requests for spatial multiplexing in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling including an indication of a set of multiple radar sensing transmit beams and a set of multiple beamwidth values associated with the set of multiple radar sensing transmit beams. The operations of 1605 may be performed in accordance with examples as disclosed herein. In some examples, aspects of the operations of 1605 may be performed by a configuration information manager 1125 as described with reference to FIG. 11.

At 1610, the method may include receiving, based on transmitting the control signaling, a scheduling request including one or more of: an indication of a set of one or more radar sensing transmit beams of the set of multiple radar sensing transmit beams, an indication of one or more beamwidth values of the set of multiple beamwidth values for respective ones of the one or more radar sensing transmit beams, or an angular area of interest for radar sensing by a UE. The operations of 1610 may be performed in accordance with examples as disclosed herein. In some examples, aspects of the operations of 1610 may be performed by a radar sensing information manager 1130 as described with reference to FIG. 11.

At 1615, the method may include transmitting, based on receiving the scheduling request, a control message indicating a grant of resources for performing radar sensing on a physical shared channel. The operations of 1615 may be performed in accordance with examples as disclosed herein. In some examples, aspects of the operations of 1615 may be performed by a grant manager 1135 as described with reference to FIG. 11.

The following provides an overview of aspects of the present disclosure:

Aspect 1: A method for wireless communications at a UE, comprising: transmitting a scheduling request comprising one or more of: an indication of a set of one or more radar sensing transmit beams, an indication of one or more beamwidth values for respective ones of the one or more radar sensing transmit beams, or an angular area of interest for radar sensing; receiving a control message indicating a grant of resources on a physical shared channel based at least in part on transmitting the scheduling request; and transmitting one or more radar signals according to the grant of resources on the physical shared channel.

Aspect 2: The method of aspect 1, further comprising: receiving control signaling comprising an indication of a relationship between a set of indices, respective radar sensing transmit beams of a plurality of radar sensing transmit beams comprising the set of one or more radar sensing transmit beams, and respective beamwidth values of a plurality of beamwidth values comprising the one or more beamwidth values.

Aspect 3: The method of aspect 2, further comprising: transmitting, in the scheduling request, one or more indices of the set of indices associated with the set of one or more radar sensing transmit beams and the one or more beamwidth values.

Aspect 4: The method of any of aspects 2 through 3, further comprising: transmitting a capability message comprising an indication that the UE is capable of supporting radar sensing and uplink signaling, wherein receiving the control signaling is based at least in part on transmitting the capability message.

Aspect 5: The method of any of aspects 1 through 4, further comprising: receiving control signaling comprising an indication of a first relationship between a first set of indices and respective radar sensing transmit beams of a plurality of radar sensing transmit beams comprising the set of one or more radar sensing transmit beams and an indication of a second relationship between a second set of indices and respective beamwidth values of a plurality of beamwidth values comprising the one or more beamwidth values.

Aspect 6: The method of aspect 5, further comprising: transmitting, in the scheduling request, one or more indices of the first set of indices associated with the set of one or more radar sensing transmit beams, and one or more indices of the second set of indices associated with the one or more beamwidth values.

Aspect 7: The method of any of aspects 5 through 6, further comprising: transmitting a capability message comprising an indication that the UE is capable of supporting simultaneous radar sensing and uplink signaling, wherein receiving the control signaling is based at least in part on transmitting the capability message.

Aspect 8: The method of any of aspects 1 through 7, wherein the indication of the set of one or more radar sensing transmit beams comprises: an indication of a direction of each of the one or more radar sensing transmit beams with reference to a coordinate system.

Aspect 9: The method of aspect 8, wherein the direction of each of the set of one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

Aspect 10: The method of any of aspects 1 through 9, further comprising: transmitting, in the scheduling request, an indication of one or more radar sensing receive beams, an indication of a position of a receiver for cooperative radar sensing, or both.

Aspect 11: The method of any of aspects 1 through 10, further comprising: transmitting, in the scheduling request, an indication of a sequence of the one or more radar sensing transmit beams, a time period associated with radar sensing on each radar sensing transmit beam of the one or more radar sensing transmit beams, or both.

Aspect 12: The method of any of aspects 1 through 11, further comprising: receiving, in the grant of resources based at least in part on transmitting the scheduling request comprising the angular area of interest for radar sensing, an indication of a sequence of the set of one or more radar sensing transmit beams associated with the angular area of interest for radar sensing, wherein transmitting the one or more radar signals according to the grant of resources on the physical shared channel comprises transmitting the one or more radar signals according to the sequence of the set of one or more radar sensing transmit beams.

Aspect 13: The method of any of aspects 1 through 12, further comprising: receiving, in the grant of resources based at least in part on transmitting the scheduling request comprising the indication of the set of one or more radar sensing transmit beams, an indication of a second set of one or more radar sensing transmit beams associated with the angular area of interest for radar sensing, wherein transmitting the one or more radar signals according to the grant of resources on the physical shared channel comprises transmitting the one or more radar signals using the second set of one or more radar sensing transmit beams.

Aspect 14: The method of aspect 13, wherein the set of one or more radar sensing transmit beams is different from the second set of one or more radar sensing transmit beams.

Aspect 15: The method of any of aspects 1 through 14, further comprising: transmitting, in the scheduling request, a threshold bandwidth for transmitting the one or more radar signals, a threshold time duration for transmitting the one or more radar signals, a threshold transmit power for transmitting the one or more radar signals, an indication of a position of the UE, or any combination thereof.

Aspect 16: A method for wireless communications at a network entity, comprising: transmitting control signaling comprising an indication of a plurality of radar sensing transmit beams and a plurality of beamwidth values associated with the plurality of radar sensing transmit beams; receiving, based at least in part on transmitting the control signaling, a scheduling request comprising one or more of: an indication of a set of one or more radar sensing transmit beams of the plurality of radar sensing transmit beams, an indication of one or more beamwidth values of the plurality of beamwidth values for respective ones of the one or more radar sensing transmit beams, or an angular area of interest for radar sensing by a UE; and transmitting, based at least in part on receiving the scheduling request, a control message indicating a grant of resources for performing radar sensing on a physical shared channel.

Aspect 17: The method of aspect 16, further comprising: receiving a capability message comprising an indication that the UE is capable of supporting simultaneous radar sensing and uplink signaling, wherein transmitting the control signaling is based at least in part on receiving the capability message.

Aspect 18: The method of any of aspects 16 through 17, wherein transmitting the control signaling comprises: transmitting an indication of a relationship between a set of indices, respective radar sensing transmit beams of the plurality of radar sensing transmit beams, and respective beamwidth values of the plurality of beamwidth values.

Aspect 19: The method of aspect 18, further comprising: receiving, in the scheduling request, one or more indices of the set of indices associated with the set of one or more radar sensing transmit beams and the one or more beamwidth values.

Aspect 20: The method of any of aspects 16 through 19, wherein transmitting the control signaling comprises: transmitting an indication of a first relationship between a first set of indices and respective radar sensing transmit beams of the plurality of radar sensing transmit beams and an indication of a second relationship between a second set of indices and respective beamwidth values of the plurality of beamwidth values.

Aspect 21: The method of aspect 20, further comprising: receiving, in the scheduling request, one or more indices of the first set of indices associated with the set of one or more radar sensing transmit beams, and one or more indices of the second set of indices associated with the one or more beamwidth values.

Aspect 22: The method of any of aspects 16 through 21, wherein the indication of the set of one or more radar sensing transmit beams comprises: an indication of a direction of each of the one or more radar sensing transmit beams with reference to a coordinate system.

Aspect 23: The method of aspect 22, wherein the direction of each of the one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

Aspect 24: The method of any of aspects 16 through 23, further comprising: receiving, in the scheduling request, an indication of one or more radar sensing receive beams, an indication of a position of a receiver for cooperative radar sensing, or both.

Aspect 25: The method of any of aspects 16 through 24, further comprising: receiving, in the scheduling request, an indication of a sequence of the one or more radar sensing transmit beams, a time period associated with radar sensing on each radar sensing transmit beam of the one or more radar sensing transmit beams, or both.

Aspect 26: The method of any of aspects 16 through 25, further comprising: identifying, based at least in part on receiving the scheduling request comprising the indication of the angular area of interest for radar sensing, a sequence of the set of one or more radar sensing transmit beams that satisfies an interference threshold associated with uplink signaling, radar sensing, or both, within the angular area of interest; and transmitting, in the grant of resources, an indication of the sequence of the set of one or more radar sensing transmit beams.

Aspect 27: The method of any of aspects 16 through 26, further comprising: identifying, based at least in part on receiving the scheduling request comprising the indication of the set of one or more radar sensing transmit beams, a second set of one or more radar sensing transmit beams that are available for radar sensing by the UE; and transmitting, in the grant of resource, an indication of the second set of one or more radar sensing transmit beams.

Aspect 28: The method of any of aspects 16 through 27, further comprising: receiving, in the scheduling request, a threshold bandwidth for transmitting one or more radar signals, a threshold time duration for transmitting each of the one or more radar signals, a threshold transmit power for transmitting the one or more radar signals, or any combination thereof.

Aspect 29: An apparatus for wireless communications at a UE, comprising a processor; memory coupled with the processor; and instructions stored in the memory and executable by the processor to cause the apparatus to perform a method of any of aspects 1 through 15.

Aspect 30: An apparatus for wireless communications at a UE, comprising at least one means for performing a method of any of aspects 1 through 15.

Aspect 31: A non-transitory computer-readable medium storing code for

wireless communications at a UE, the code comprising instructions executable by a processor to perform a method of any of aspects 1 through 15.

Aspect 32: An apparatus for wireless communications at a network entity, comprising a processor; memory coupled with the processor; and instructions stored in the memory and executable by the processor to cause the apparatus to perform a method of any of aspects 16 through 28.

Aspect 33: An apparatus for wireless communications at a network entity, comprising at least one means for performing a method of any of aspects 16 through 28.

Aspect 34: A non-transitory computer-readable medium storing code for wireless communications at a network entity, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory in electronic communication with the processor; and
instructions stored in the memory, wherein the instructions are executable by the processor to:
transmit a scheduling request comprising one or more of: an indication of a set of one or more radar sensing transmit beams, an indication of one or more beamwidth values for respective ones of the one or more radar sensing transmit beams, or an angular area of interest for radar sensing;
receive a control message indicating a grant of resources on a physical shared channel based at least in part on transmitting the scheduling request; and
transmit one or more radar signals according to the grant of resources on the physical shared channel.

2. The apparatus of claim 1, wherein the instructions are further executable by the processor to:
receive control signaling comprising an indication of a relationship between a set of indices, respective radar sensing transmit beams of a plurality of radar sensing transmit beams comprising the set of one or more radar sensing transmit beams, and respective beamwidth values of a plurality of beamwidth values comprising the one or more beamwidth values.

3. The apparatus of claim 2, wherein the instructions executable by the processor to transmit the scheduling request comprise instructions executable by the processor to:
transmit, in the scheduling request, one or more indices of the set of indices associated with the set of one or more radar sensing transmit beams and the one or more beamwidth values.

4. The apparatus of claim 2, wherein the instructions are further executable by the processor to:
transmit a capability message comprising an indication that the UE is capable of supporting radar sensing and uplink signaling, wherein receiving the control signaling is based at least in part on transmitting the capability message.

5. The apparatus of claim 1, wherein the instructions are further executable by the processor to:
receive control signaling comprising an indication of a first relationship between a first set of indices and respective radar sensing transmit beams of a plurality of radar sensing transmit beams comprising the set of one or more radar sensing transmit beams and an indication of a second relationship between a second set of indices and respective beamwidth values of a plurality of beamwidth values comprising the one or more beamwidth values.

6. The apparatus of claim 5, wherein the instructions executable by the processor to transmit the scheduling request comprise instructions executable by the processor to:
transmit, in the scheduling request, one or more indices of the first set of indices associated with the set of one or more radar sensing transmit beams, and one or more indices of the second set of indices associated with the one or more beamwidth values.

7. The apparatus of claim 5, wherein the instructions are further executable by the processor to:
transmit a capability message comprising an indication that the UE is capable of supporting simultaneous radar sensing and uplink signaling, wherein receiving the control signaling is based at least in part on transmitting the capability message.

8. The apparatus of claim 1, wherein the indication of the set of one or more radar sensing transmit beams comprises:
an indication of a direction of each of the one or more radar sensing transmit beams with reference to a coordinate system.

9. The apparatus of claim 8, wherein the direction of each of the set of one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

10. The apparatus of claim 1, wherein the instructions executable by the processor to transmit the scheduling request comprise instructions executable by the processor to:
transmit, in the scheduling request, an indication of one or more radar sensing receive beams, an indication of a position of a receiver for cooperative radar sensing, or both.

11. The apparatus of claim 1, wherein the instructions executable by the processor to transmit the scheduling request comprise instructions executable by the processor to:
transmit, in the scheduling request, an indication of a sequence of the one or more radar sensing transmit beams, a time period associated with radar sensing on each radar sensing transmit beam of the one or more radar sensing transmit beams, or both.

12. The apparatus of claim 1, wherein the instructions executable by the processor to receive the control message indicating the grant of resources comprise instructions executable by the processor to:
receive, in the grant of resources based at least in part on transmitting the scheduling request comprising the angular area of interest for radar sensing, an indication of a sequence of the set of one or more radar sensing transmit beams associated with the angular area of interest for radar sensing, wherein transmitting the one or more radar signals according to the grant of resources on the physical shared channel comprises transmitting the one or more radar signals according to the sequence of the set of one or more radar sensing transmit beams.

13. The apparatus of claim 1, wherein the instructions executable by the processor to receive the control message indicating the grant of resources comprise instructions executable by the processor to:
receive, in the grant of resources based at least in part on transmitting the scheduling request comprising the indication of the set of one or more radar sensing transmit beams, an indication of a second set of one or more radar sensing transmit beams associated with the angular area of interest for radar sensing, wherein transmitting the one or more radar signals according to the grant of resources on the physical shared channel comprises transmitting the one or more radar signals using the second set of one or more radar sensing transmit beams.

14. The apparatus of claim 13, wherein the set of one or more radar sensing transmit beams is different from the second set of one or more radar sensing transmit beams.

15. The apparatus of claim 1, wherein the instructions executable by the processor to transmit the scheduling request comprise instructions executable by the processor to:
transmit, in the scheduling request, a threshold bandwidth for transmitting the one or more radar signals, a threshold time duration for transmitting the one or more radar signals, a threshold transmit power for transmitting the one or more radar signals, an indication of a position of the UE, or any combination thereof.

16. An apparatus for wireless communications at a network entity, comprising:
a processor;
memory coupled with the processor; and
instructions stored in the memory and executable by the processor to cause the apparatus to:
transmit control signaling comprising an indication of a plurality of radar sensing transmit beams and a plurality of beamwidth values associated with the plurality of radar sensing transmit beams;
receive, based at least in part on transmitting the control signaling, a scheduling request comprising one or more of: an indication of a set of one or more radar sensing transmit beams of the plurality of radar sensing transmit beams, an indication of one or more beamwidth values of the plurality of beamwidth values for respective ones of the one or more radar sensing transmit beams, or an angular area of interest for radar sensing by a UE; and
transmit, based at least in part on receiving the scheduling request, a control message indicating a grant of resources for performing radar sensing on a physical shared channel.

17. The apparatus of claim 16, wherein the instructions are further executable by the processor to:
receive a capability message comprising an indication that the UE is capable of supporting simultaneous radar sensing and uplink signaling, wherein the instructions executable by the processor to transmit the control signaling are based at least in part on the instructions executable by the processor to receive the capability message.

18. The apparatus of claim 16, wherein the instructions executable by the processor to transmit the control signaling comprise instructions executable by the processor to:
transmit an indication of a relationship between a set of indices, respective radar sensing transmit beams of the plurality of radar sensing transmit beams, and respective beamwidth values of the plurality of beamwidth values.

19. The apparatus of claim 18, wherein the instructions executable by the processor to receive the scheduling request comprise instructions executable by the processor to:
receive, in the scheduling request, one or more indices of the set of indices associated with the set of one or more radar sensing transmit beams and the one or more beamwidth values.

20. The apparatus of claim 16, wherein the instructions executable by the processor to transmit the control signaling comprises instructions executable by the processor to:
transmit an indication of a first relationship between a first set of indices and respective radar sensing transmit beams of the plurality of radar sensing transmit beams and an indication of a second relationship between a second set of indices and respective beamwidth values of the plurality of beamwidth values.

21. The apparatus of claim 20, wherein the instructions executable by the processor to receive the scheduling request comprise instructions executable by the processor to:
receive, in the scheduling request, one or more indices of the first set of indices associated with the set of one or more radar sensing transmit beams, and one or more indices of the second set of indices associated with the one or more beamwidth values.

22. The apparatus of claim 16, wherein the indication of the set of one or more radar sensing transmit beams comprises:
an indication of a direction of each of the one or more radar sensing transmit beams with reference to a coordinate system.

23. The apparatus of claim 22, wherein the direction of each of the one or more radar sensing transmit beams indicates a spatial region within which a total beam pattern gain satisfies a threshold power level, a spatial region that contains a threshold portion of a total radiated power, a spatial region within which a total radiated power satisfies a threshold, or a combination thereof.

24. The apparatus of claim 16, wherein the instructions executable by the processor to receive the scheduling request are further executable by the processor to cause the apparatus to:
receive, in the scheduling request, an indication of one or more radar sensing receive beams, an indication of a position of a receiver for cooperative radar sensing, or both.

25. The apparatus of claim 16, wherein the instructions executable by the processor to receive the scheduling request comprise instructions executable by the processor to:
receive, in the scheduling request, an indication of a sequence of the one or more radar sensing transmit beams, a time period associated with radar sensing on each radar sensing transmit beam of the one or more radar sensing transmit beams, or both.

26. The apparatus of claim 16, wherein the instructions are further executable by the processor to:
identify, based at least in part on receiving the scheduling request comprising the indication of the angular area of interest for radar sensing, a sequence of the set of one or more radar sensing transmit beams that satisfies an interference threshold associated with uplink signaling, radar sensing, or both, within the angular area of interest; and
transmit, in the grant of resources, an indication of the sequence of the set of one or more radar sensing transmit beams.

27. The apparatus of claim 16, wherein the instructions are further executable by the processor to:
identify, based at least in part on receiving the scheduling request comprising the indication of the set of one or more radar sensing transmit beams, a second set of one or more radar sensing transmit beams that are available for radar sensing by the UE; and
transmit, in the grant of resource, an indication of the second set of one or more radar sensing transmit beams.

28. The apparatus of claim 16, wherein the instructions executable by the processor to receive the scheduling request comprise instructions executable by the processor to:
receive, in the scheduling request, a threshold bandwidth for transmitting one or more radar signals, a threshold time duration for transmitting each of the one or more radar signals, a threshold transmit power for transmitting the one or more radar signals, or any combination thereof.

29. A method for wireless communications at a user equipment (UE), comprising:
transmitting a scheduling request comprising one or more of: an indication of a set of one or more radar sensing transmit beams, an indication of one or more beamwidth values for respective ones of the one or more radar sensing transmit beams, or an angular area of interest for radar sensing;
receiving a control message indicating a grant of resources on a physical shared channel based at least in part on transmitting the scheduling request; and
transmitting one or more radar signals according to the grant of resources on the physical shared channel.

30. A method for wireless communications at a network entity, comprising:
transmitting control signaling comprising an indication of a plurality of radar sensing transmit beams and a plurality of beamwidth values associated with the plurality of radar sensing transmit beams;
receiving, based at least in part on transmitting the control signaling, a scheduling request comprising one or more of: an indication of a set of one or more radar sensing transmit beams of the plurality of radar sensing transmit beams, an indication of one or more beamwidth values of the plurality of beamwidth values for respective ones of the one or more radar sensing transmit beams, or an angular area of interest for radar sensing by a UE; and
transmitting, based at least in part on receiving the scheduling request, a control message indicating a grant of resources for performing radar sensing on a physical shared channel.
